(19) United States
(12) Patent Application Publication
(10) Pub. No.: US 2018/0232352 A1
(43) Pub. Date: Aug. 16, 2018

(54) DIGITAL CONTENT INFRASTRUCTURE

(71) Applicant: QUANSER CONSULTING INC., Markham (CA)

(72) Inventors: Cameron Darryl FULFORD, Ajax (CA); Safwan CHOUDHURY, Thornhill (CA); Daniel Richard MADILL, Guelph (CA); Thomas Won-Joon LEE, Waterloo (CA); Agop Jean Georges APKARIAN, Toronto (CA); Paul John GILBERT, Thornhill (CA); Paul KARAM, Pickering (CA)

(21) Appl. No.: 15/516,639

(22) PCT Filed: Oct. 2, 2015
(86) PCT No.: PCT/CA2015/000528

§ 371 Date: Apr. 3, 2017

(51) Int. Cl. G06F 17/27; G06F 17/30

(52) U.S. Cl. CPC G06F 17/271; G06F 17/30011

(57) ABSTRACT

Systems for authoring digital content comprising at least one subsystem configured to receive at least one inputs from an author indicating content to be included for delivery; at least one subsystem configured to parse the inputs and generate platform-independent content; at least one subsystem configured to generate and layout platform-specific content. Systems for consuming digital content, comprising: at least one subsystem configured to select content for consumption by a content consumer; at least one subsystem configured to provide an interface for consumption of content by the content consumer; and at least one subsystem configured to receive and process interactions from the content consumer specific to a device used by the content consumer. The systems may further comprise at least one subsystem for interacting with one or more objects under test.

### CROSS REFERENCE

This application is a non-provisional of U.S. Application No. 62/059,533 filed Oct. 3, 2014 incorporated herein by reference. This application claims all benefit, including priority of, U.S. Application No. 62/059,533.

### FIELD

Some embodiments relate generally to digital content systems, and more particularly to systems and methods for the authoring, deployment and/or consumption of digital content.

### INTRODUCTION

Existing solutions for deploying digital content for consumption have been slow to progress. There has been limited advancement beyond printed documents.

An opportunity with digital content is the ability to manipulate and present information in many ways that were not previously possible with printed media, and the ability to transfer, share and collaborate across a multitude of devices.

The provisioning of digital content has been provided mainly in the form of web portals, accessible over the internet. These tools have been rudimentary and often do not format or scale well to the various devices/systems where content is authored and/or consumed.

### SUMMARY

The present disclosure relates to systems and methods for authoring, deploying, and consuming digital content.

In a first aspect, a computer-implemented system is provided, the system providing a digital content infrastructure on one or more computing devices having one or more processors and one or more non-transitory computer readable media, the system comprising: an authoring unit configured to: receive machine-readable input media from a content author, the machine-readable input media being provided in a platform independent format, pre-process the received machine-readable input media to generate a platform independent document bundle comprised of raw content files, and transmit the platform independent bundle for distribution to one or more content presentation units the one or more content presentation units, each of the one or more content presentation unit corresponding to a recipient computing device of the one or more the recipient computing devices, the each of one or more content presentation units configured to: receive the platform independent bundle from the authoring unit; detect or determine device configuration or presentation data for the respective recipient computing device; transform the platform independent document bundle using device configuration or presentation data to generate one or more platform specific bundles configured for use with the respective recipient computing device; and communicate, through a user interface having at least a display, platform specific content based at least on information provided in the platform specific bundle.

In another aspect, the system is implemented as a set of distributed networking computer resources connected via network infrastructure.

In another aspect, the platform independent format includes at least one of plain text, LaTeX, MS word, and media files.

In another aspect, the recipient computing devices include at least one of smart phones, tablet computers, and laptop computers.

In another aspect, the content presentation unit is configured to process the platform independent bundle to generate the platform specific bundle by: identifying one or more available features of the recipient computing device, the one or more available features being at least a portion of the device configuration or presentation data; identifying one or more unavailable features of the recipient computing device, the one or more unavailable features being at least a portion of the device configuration or presentation data; transforming the raw content files or the machine readable input media included in the platform independent bundle to associate the raw content files or the machine readable input media with the one or more available features of the recipient computing device; traversing the raw content files or the machine readable input media to determine whether there are any raw content files or the machine readable input media that cannot be provisioned using only the one or more available features of the recipient device; and generating a placeholder object for incorporation the platform specific bundle associated with the raw content files or the machine readable input media to indicate which of the raw content files or the machine readable input media cannot be provisioned using only the one or more available features of the recipient device.

In another aspect, the authoring unit is configured to associate, with the raw content files of the platform independent content bundle, one or more metadata tags adapted for searching and fetching operations.

In another aspect, the one or more available features of the recipient computing device include at least one of gesture recognition, a camera, a proximity sensor, a gyroscope, an accelerometer, a location sensor, touchscreen capabilities and a temperature sensor.

In another aspect, the machine-readable input media is provided in XML including at least a portion in NLua scripting language.

In another aspect, the machine-readable input media includes machine-readable scripts adapted for utilizing computer-implemented features at the one or more content presentation units to facilitate the display or control of at least one of multi-rate simulations, interactions with a physical object under test, timers, algebraic loops, and plotted mathematical computations.

In another aspect, the machine-readable input media includes machine-readable scripts adapted for simultaneously performing a simulation and performing experiments with a physical object under test.

In another aspect, the device configuration or presentation data comprises an operating system, a form factor, a screen size, and a resolution of each of the one or more recipient devices, display type, display size, available memory or processing or communication resources, available display features, available output devices, available input devices, connection resources, communication protocol or a combination thereof.

A computer-implemented system for providing a digital content infrastructure on one or more computing devices having one or more processors and one or more non-transitory computer readable media, the system comprising: an authoring unit configured to: receive machine-readable input media from a content author, the machine-readable input media being provided in a platform independent format, pre-process the received machine-readable input media to generate a platform independent document bundle comprised of raw content files, and transmit the platform independent bundle for distribution to one or more content presentation units the one or more content presentation units, each of the one or more content presentation unit corresponding to a recipient computing device of the one or more the recipient computing devices, the each of one or more content presentation units configured to: receive the platform independent bundle from the authoring unit; detect or determine device configuration or presentation data for the respective recipient computing device; transform the platform independent document bundle using device configuration or presentation data to generate one or more platform specific bundles configured for use with the respective recipient computing device; and communicate, through a user interface having at least a display, platform specific content based at least on information provided in the platform specific bundle; and a physical hardware abstraction unit configured to: establish a connection to one or more physical objects under test; generate experimental data in real time or near real time based on monitoring of one or more characteristics of the one or more physical objects under test; programmatically interface with the one or more physical objects under test to manipulate one or more parameters associated with the operation of the one or more physical objects under test by causing the actuation of physical components of the one or more physical objects under test; and wherein the one or more content presentation units are operably connected to the physical hardware abstraction unit and configured to: initiate a request for experimental data by providing the request to the physical hardware abstraction unit; transmit, through the physical hardware abstraction unit, instructions for manipulating the one or more parameters thereby causing the actuation of components of the one or more physical objects under test; receive the experimental data from the physical hardware abstraction unit; and display the experimental data through the user interface of the content presentation unit.

In another aspect, the display of the experimental data through the user interface of the content presentation unit includes displaying the experimental data in-line with the information provided in the platform specific bundle.

In another aspect, each of the one or more content presentation units are configured to facilitate, through the user interface, interactions with the experimental data.

In another aspect, interactions with the experimental data include at least one manipulations associated with the plotting of the experimental data.

In another aspect, the physical hardware abstraction unit includes one or more predefined interfaces that is provided to the one or more content presentation units in the form of a computer-implemented library of possible manipulations for interaction with the physical object under test.

In another aspect, the physical hardware abstraction unit is configured to dynamically generate one or more dynamic manipulation interfaces based at least on information received from the physical object under test indicating one or more capabilities of the physical object under test, and one or more available features of the or more content presentation units, the one or more dynamic manipulation interfaces used to manipulate the one or more parameters associated with the operation of the one or more physical objects under test.

In another aspect, the authoring unit is configured to provide a computer-implemented library of tools that are utilized by a user of the authoring unit to generate a plurality of logical rules defining the one or more parameters available for manipulation of the one or more physical objects under test; and defining the one or more characteristics of the one or more physical objects under test and how the one or more characteristics are affected by the one or more parameters.

In another aspect, the instructions for manipulating the one or more parameters are predefined in accordance with an experiment, and the physical hardware abstraction unit is configured to automatically initiate the experiment based on the received instructions.

In another aspect, the one or more physical objects under test includes at least one of an inverted pendulum, an electronic circuit, a mechanical system, a biological system, an apparatus containing a biological reaction, and an apparatus containing a chemical reaction.

In another aspect, the physical hardware abstraction unit includes at least one camera oriented towards the one or more physical objects under test, and the one or more content presentation units are configured to receive photographic information from the at least one camera and provide the photographic information to the displays of the one or more recipient computing devices.

In another aspect, the one or more content presentation units are configured to overlay topographical information on the received photographic information from the at least one camera to provide an augmented reality view to the displays of the one or more recipient computing devices.

In another aspect, the topographical information is based at least on the received experimental data.

In another aspect, the topographical information is based at least on a difference between the received experimental data and theoretical data.

In another aspect, the difference is determined on a visual point-by-point basis.

In another aspect, the one or more physical objects under test are provided at a facility remote from the one or more content presentation units and the one or more recipient computing devices.

In another aspect, the one or more content presentation units are configured to apply consistent styling and themes by receiving user interface theme information from the authoring unit.

In another aspect, the authoring unit is configured to: validate contents of the platform independent document bundle by verifying that all referenced local resources exist and can be opened.

In another aspect, to pre-process the received machine-readable input media to generate a platform independent document bundle includes parsing the received machine-readable input media to determine which media includes mathematical equations; and wherein the authoring unit is configured to validate the syntax of the mathematical equations; and pre-render validated mathematical equations as rendered images.

In another aspect, the authoring unit is provided with a backend repository.

In another aspect, the one or more content presentation units are configured to stream data to one or more other content presentation units.

In another aspect, the one or more content presentation units includes a simulation engine configured to: generate simulations of mathematical relationships based at least on information provided in the platform specific bundle; display representations of the simulations through the user interfaces of the one or more content presentation units.

In another aspect, the simulated mathematical relationships include one or more cyclic graphs having one or more algebraic loops; and the simulation engine that is configured to break one or more algebraic loops.

In another aspect, the simulation engine is configured to determine whether each of the one or more algebraic loops converges over time.

In another aspect, the simulation engine is configured to determine whether each of the one or more algebraic loops diverges over time.

In another aspect, the simulation engine is configured to determine whether each of the one or more algebraic loops converges over time by iteratively calculating signal values in each of the of the one or more algebraic loops.

In another aspect, the simulation engine is configured to: insert a unit delay in each of the one or more algebraic loops; determine an acyclic execution order of steps each of the one or more algebraic loops; and evaluate the acyclic execution order to determine whether the one or more algebraic loops should be broken.

In another aspect, the simulation engine is configured to: determine optimal positions where the one or more unit delays should be inserted into each of the one or more algebraic loops

In another aspect, the simulation engine is configured to generate the simulations alongside an experiment provisioned through the physical hardware abstraction unit of claim 12.

In another aspect, the one or more simulations are provided at a first time rate, and the experiment is provided at a second time rate; and wherein the first time rate and the second time rate are different from one another.

In another aspect, the simulation engine is configured to traverse the graph structure of the simulated mathematical relationships to identify rate-transition parameters required to synchronize the first time rate and the second rate; and insert the rate-transition parameters such that the first time rate and the second time rate are synchronized.

In another aspect, a computer-implemented method is provided, the method comprising: receiving machine-readable input media from a content author, the machine-readable input media being provided in a platform independent format, pre-processing the received machine-readable input media to generate a platform independent document bundle comprised of raw content files, and transmitting the platform independent bundle for distribution to one or more content presentation units.

In another aspect, a computer-implemented method is provided, the method comprising: receiving a platform independent bundle; detecting or determining device configuration or presentation data for the respective recipient computing device; transforming the platform independent document bundle using device configuration or presentation data to generate one or more platform specific bundles configured for use with the respective recipient computing device; and communicating, through a user interface having at least a display, platform specific content based at least on information provided in the platform specific bundle.

In another aspect, a computer-implemented method is provided, the method comprising: identifying one or more available features of a recipient computing device, the one or more available features being at least a portion of a device configuration or presentation data; identifying one or more unavailable features of the recipient computing device, the one or more unavailable features being at least a portion of the device configuration or presentation data; transforming raw content files or machine readable input media included in the platform independent bundle to associate the raw content files or the machine readable input media with the one or more available features of the recipient computing device; traversing the raw content files or the machine readable input media to determine whether there are any raw content files or the machine readable input media that cannot be provisioned using only the one or more available features of the recipient device; and generating a placeholder object for incorporation the platform specific bundle associated with the raw content files or the machine readable input media to indicate which of the raw content files or the machine readable input media cannot be provisioned using only the one or more available features of the recipient device.

In another aspect, a computer-implemented method is provided, the method comprising: receiving, by an authoring unit, machine-readable input media from a content author, the machine-readable input media being provided in a platform independent format, pre-processing, by the authoring unit, the received machine-readable input media to generate a platform independent document bundle comprised of raw content files, transmitting, by the authoring unit, the platform independent bundle for distribution to one or more content presentation units each of the one or more content presentation unit corresponding to a recipient computing device of the one or more the recipient computing devices; receiving, by the one or more recipient computing devices, the platform independent bundle from the authoring unit; detecting or determining, by the one or more recipient computing devices, device configuration or presentation data for the respective recipient computing device; transforming, by the one or more recipient computing devices, the platform independent document bundle using device configuration or presentation data to generate one or more platform specific bundles configured for use with the respective recipient computing device; and communicating, through a user interface having at least a display, platform specific content based at least on information provided in the platform specific bundle; establishing, by a physical hardware abstraction unit, a connection to one or more physical objects under test; generating, by the physical hardware abstraction unit, experimental data in real time or near real time based on monitoring of one or more characteristics of the one or more physical objects under test; and programmatically interfacing, by the physical hardware abstraction unit, with the one or more physical objects under test to manipulate one or more parameters associated with the operation of the one or more physical objects under test by causing the actuation of physical components of the one or more physical objects under test.

In another aspect, a system is provided for authoring digital content comprising: at least one subsystem configured to receive inputs from an author indicating content to be included for delivery; at least one subsystem configured to parse the inputs and generate platform-independent content; at least one subsystem configured to parse the inputs to define one or more mathematical systems, each of the mathematical systems having a simulation rate and having one or more algebraic loops to be solved iteratively; at least one subsystem configured for determining the simulation rate of each of the mathematical systems and inserting rate-transition parameters to synchronize signal flow across the mathematical systems.

In another aspect, a system is provided for authoring digital content comprising: at least one subsystem configured to receive inputs from an author indicating content to be included for delivery; at least one subsystem configured to parse the inputs and generate platform-independent content; at least one object under test that is configured for communicating with the system; at least one subsystem configured to dynamically define interfaces for interaction with the at least one object under test based at least on a library of pre-defined interfaces.

In another aspect, a system is provided for consuming digital content, comprising: at least one subsystem configured to select content for consumption by a content consumer; at least one subsystem configured to provide an interface for consumption of content by the content consumer; at least one subsystem configured to receive and process interactions from the content consumer specific to a device used by the content consumer; at least one subsystem configured to generate and layout platform-specific content; at least one subsystem configured to simulate one or more mathematical systems having a simulation rate and having one or more algebraic loops to be solved iteratively; and at least one subsystem configured to detect that an algebraic loop has failed to converge, and upon detection of the algebraic loop has failed to converge, to automatically break the algebraic loop at a loop breaking point.

In another aspect, a system is provided for consuming digital content, comprising: at least one subsystem configured to select content for consumption by a content consumer; at least one subsystem configured to provide an interface for consumption of content by the content consumer; at least one subsystem configured to receive and process interactions from the content consumer specific to a device used by the content consumer; at least one subsystem configured to generate and layout platform-specific content; at least one object under test that is configured for communicating with the system and operating based on a set of parameters communicated to the at least one object under test by the system; at least one subsystem configured to simulate one or more mathematical systems related to the operation of the at least one object under test; and at least one subsystem configured to overlay the simulation of the mathematical system on a graphical representation of the at least one object under test.

In another aspect, a system is provided wherein the system comprises at least one subsystem for streaming data between one or more systems.

In this respect, before explaining at least one embodiment in detail, it is to be understood that embodiments are not limited in its application to the details of construction and to the arrangements of the components set forth in the following description or illustrated in the drawings. Embodiments may be capable of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding.

FIG. 1A is a high level flowchart of the system, according to some embodiments.

FIG. 1B is a high level flowchart of the system, according to some embodiments.

FIG. 2 is an example schematic providing a block diagram of the content player system, according to some embodiments.

FIG. 3 is a more detailed block diagram of the content player system, according to some embodiments.

FIG. 4 provides a block diagram where an interface is being dynamically defined, according to some embodiments.

FIG. 5 shows a model with an algebraic loop/cycle, according to some embodiments.

FIG. 6 shows a model where algebraic loop has been broken by inserting a signal delay that samples and holds the signal value, according to some embodiments.

FIG. 7 shows a model with multiple algebraic loops, according to some embodiments.

FIG. 8 shows a model where a single unit delay is provided, according to some embodiments.

FIG. 9 provides a sample flow chart for simulation timing and execution, according to some embodiments.

FIG. 10 provides a sample diagram indicating how devices may connect, according to some embodiments.

FIG. 11 provides a sample diagram illustrating streaming from an instruction's device to a number of student devices, according to some embodiments.

FIGS. 12-15 provide various screen captures according to some embodiments.

FIG. 16 provides a computing device that may be used in implementing some functionality of a system, according to some embodiments.

FIGS. 17-20 provide example workflows, according to some embodiments.

### DETAILED DESCRIPTION

Many solutions simply provide static content online, and consumers often have to resort to third party applications and/or programs to be able to collaborate, provide interactive objects, utilize augmented reality, conduct simulations, plot graphics, or run experimentation on hardware simulations (using virtual or physical hardware).

Input means are often limited to simply mouse/keyboard implementations, whereas many devices are now equipped with functionality with a wide range of inputs (e.g. touchscreen, microphones, cameras) and sensors.

Many solutions are based on personal computer technology, and few solutions have migrated to the realm of mobile devices. Even for those solutions that have migrated to mobile devices, they are relatively simple and do not take full advantage of the device capabilities, including sensors and tactile functionality.

Currently, there are issues in the generation, deployment and consumption of digital content in the educational industry. Especially in the fields of applied sciences, generating content is difficult and often time-consuming where content to be generated often requires the display of complex mathematical formulae, simulation of various systems, among others. It is a further challenge to generate content that is displayed and formatted properly across various devices.

Tools for generating content may often be rudimentary and limit the ability of the author to easily generate content beyond simple textual inputs.

On the deployment of digital content for consumption, there are also various shortfalls. These include the inability to conveniently interact with content, such as graphs and formulae, and an inability to conveniently conduct experiments or run simulations.

As content is typically provided in the form of simple text-based web pages, content is often formatted poorly for the devices they run on (e.g. a computer, a mobile device). Many existing digital content development tools are designed to provide “what you see is what you get” (WYSIWYG) functionality, which may mean that the tools use non-native controls and widgets and poorly formatted layouts for different device form factors. A potential advantage for tools that are not WYSIWYG may be that authors may be allowed the freedom to write content independent of layout constraints as layouts may be automatically performed using content elements native to the platform on which it is rendered, helping promote a native look and feel.

The deployment of digital content can be used in a wide range of contexts and scenarios, non-limiting examples may include:
Development of Digital Product Information Sheets (PIS) for manufacturers of technical and non-technical components;
Development of product flyers and/or catalogs for brick-and-mortar or online retailers;
Corporate training materials for companies (e.g., in the financial sector) which utilize the mathematical solvers, interactive plots and simulation capabilities of the proposed system to execute complex simulations for the purposes of training;
Displaying research papers in a digital format for biochemical conference proceedings with interactive models of molecules (using 3D visualizations) and simulations;
Displaying white papers with interactive content from components manufacturers in any industry; and
Interactivity with any wirelessly enabled device (e.g., smart home appliances).

As an example, a chemical engineering professor at a university may wish to generate content related to a course on thermodynamics. The chemical engineering professor may further wish to connect the content she has developed with a physical experiment where temperature can be controlled in a given apparatus, and various sensory inputs can be recorded during the course of the experiment.

However, most content is generated in textual and pictorial formats and the professor has little to no ability to provide interactive, experimental or simulation functionality without either utilizing a third party application or programming functionality.

As a similar example, a teacher at a high school may wish to have an interactive session with a number of students, where the students are able to interact, using their devices, with the teacher's device, and the teacher is able to provide lesson elements in a one to many, a one to one, or in a group format to the students. The students may wish to be able to indicate to the teacher which answer is correct, submit their work, collaborate with one another, etc. Currently, such an interactive session would be difficult to implement in an easy-to-develop and easy-to-consume format.

The student may utilize her mobile device to access course content, but the current displays are still limited to text and simple graphics with very limited integration with the capabilities of her mobile device. The student may also need to utilize third party applications or other software or hardware to be able to render simulations, interact with graphs or interact/control hardware implementations. This may take a considerable amount of time and resources on the part of the student.

A challenge is the diversity of mobile platforms and devices. The spectrum of mobile platforms may contain a broad range of operating systems, form factors, sensors, and computing capabilities. These mobile platforms and devices may further have a set of native tools and features whose potential is not fully taken advantage of by current technologies.

Another challenge is the portability of content and layouts already developed as applied to future systems and platforms.

A new solution is thus needed to overcome the shortfalls of the currently available technologies.

### 1. Overview

In some embodiments, a system for authoring, deploying, and consuming digital content is provided.

The system may be comprised of various elements, such as an application located on a mobile device, web/cloud-based system, or personal computer for consuming digital content, and/or desktop, mobile, or cloud-based elements for authoring and/or deploying digital content. In some embodiments, the system may be configured to utilize various functionality native to the devices hosting various elements of the system, such as on-board cameras, microphones, touchscreens (e.g., for gesture support), etc.

The authoring, deploying and/or consuming of digital content may, in various embodiments, be conducted on mobile devices, desktop/personal computers, and/or cloud-based/web-based systems. As a non-limiting, illustrative example, in some embodiments, authoring, deploying and consuming content may be conducted on mobile devices.

The content may be created in various formats, including source code formats, or with the help of authoring tools.

In various embodiments, the system may be configured to operate off-line, on-line, or both on-line and off-line. For example, while the system may be off-line, a user could still access some or all of the content available to that user.

Where the system is configured to operate both on-line and off-line, various elements that operate on-line, such as account synchronizing, may take the state of the system into consideration and postpone various tasks until the system is back on-line.

The system may provide for the authoring, deployment and consumption of digital content modules across various technology platforms, including, but not limited to, mobile devices. This system may be utilized, for example, in the educational industry, or any situations where the consumption of content may be of interest. In one aspect, a system is provided, which may implemented as a computer implemented system, that provides one or more tools that enable authoring, deployment and consumption of digital content modules that enable users to interact with technical content in a dynamic and engaging way, including using interaction capabilities such as gestures, sensory inputs, etc.

Content may contain various teaching elements, appropriate for a given subject matter, including curriculum documents, background, fundamental theory, pre-laboratory exercises, dynamic simulations, plotting and analysis tools, in-laboratory objects under test interaction, 2D/3D visualization, as well as multimedia for motivation and exploration.

The system may be useful in a classroom environment, but may also be utilized across a broad range of potential applications where content is authored and consumed. The system, in various embodiments, may be configured for enabling collaboration, social networking, visualization, etc., and may further be optimized through the use of abstraction frameworks, application programming interfaces (APIs) to access functionality/features that are native to a particular device or technology, etc.

The system may also be interoperable with various objects under test, which may include external systems, hardware, apparatuses, etc., that the system can interface with. These objects under test may be physical objects or virtual objects.

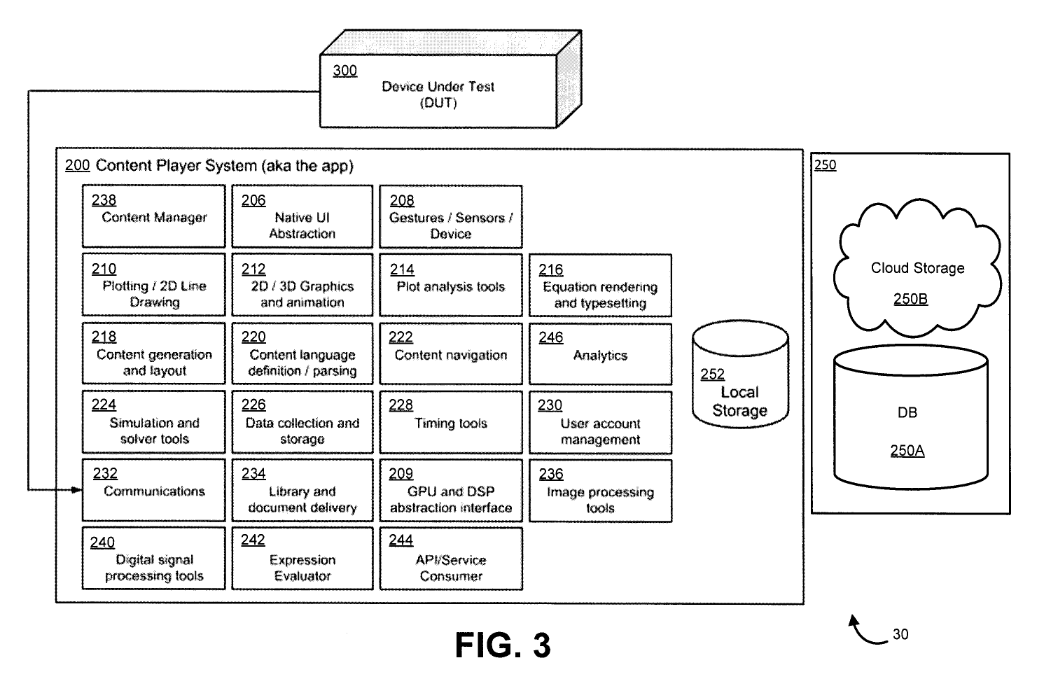

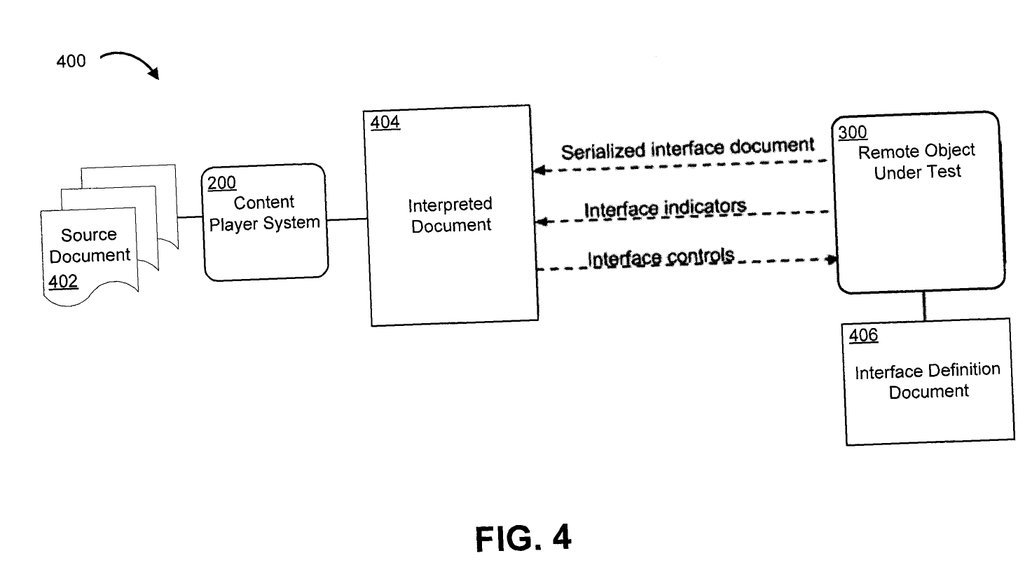

In some embodiments, the authors and content consumers may also interact with one or more objects under test that may be controlled and/or simulated using the system. The objects under test may be virtual (e.g., simulated) or actual physical objects under test. For example, a physical object under test may be an object such as the Quanser QUBE™, which is a device designed to perform a variety of servo-motor control and pendulum based experiments. Other objects under test may include various experimental apparatuses, such as electronic circuits, mechanical systems, apparatuses containing biological or chemical reactions, etc. An object under test may be illustrated in FIGS. 3 and 4, with FIG. 3 being a schematic diagram of application modules (210-246) that may interoperate with an object under test (300), and FIG. 4 being a sample flowchart illustrative of how interfaces may be defined for interaction with one or more objects under test (300).

The system (10) may be configured to provide an interface or connectivity layer that enables the system to interact and/or interoperate with one or more objects under test (300). In some embodiments, the system (10) may be configured to generate and/or define interfaces with objects under test (300) in which there may be no pre-set interface (e.g. an object whose interfaces may not be already known to the system (10)).

The system (10) may be configured to enable authors to specify what data is sent over a communication stream and/or various interfaces and what to do with received data.

In the example where the Quanser QUBE™ is utilized, an author could specify that the “send” packet would contain some number of values and where this data comes from (e.g., numeric inputs, sliders, etc). The author may also specify that he/she expects certain data in the received packet and that it should be connected semantically to plot curves/displays (indicators).

Connectivity may be provided to allow results to be transferred from the system (10) to external devices and also for streaming data from objects under test (300) for various purposes. For example, a device controlling the balancing of an inverted pendulum may be remotely located, and a content consumer may wish to view and run tests on such a device.

For example, the system (10) may interface with an experimental apparatus, such as an electric kettle where a thermodynamics experiment is being conducted, send commands to it and receive feedback from the apparatus. In some embodiments, additional features such as augmented reality, etc., may provide an enhanced ability for a user to visualize various elements related to the various phenomena and reactions taking place within the electric kettle.

These interactive functions may augment traditional types of plots and simulations by providing video, 2D/3D animations, live video streams of remotely located hardware and/or interactive plots of functions.

In some embodiments, the author can further create content in portable document sections that can be reused across multiple documents.

The system for deploying digital content for mobile devices may advantageously apply functionality (e.g., sensors, sensory inputs, touch interfaces mobile user interfaces, attachable peripherals, other applications, existing software) and processing capabilities (e.g., graphics processing, on-board processing chips) for the generation, deployment and consumption of digital content.

In some embodiments, a content markup language may be utilized in order to facilitate the development of content modules independently from the system (e.g., content player, computational software, etc.), which may also help with portability of the content already developed to future systems and platforms.

To address challenges inherent in the variability of multiple platforms, the system (10) may provide functionality that abstracts an application's content from the user interface. In some embodiments, the system (10) may be configured to utilize functionality native to various platforms for rendering and/or enabling interactions with content, thus potentially increasing device compatibility and portability through abstraction.

The system (10) may be implemented using various means and various technologies. In some embodiments, the system may be implemented using one or more servers, one or more processors, one or more non-transitory computer-readable media, one or more interfaces, etc.

In alternate embodiments, the system may be implemented using distributed computing and network technologies, such as cloud computing implementations. For example, in these implementations, a number of devices may work together in forming virtual hardware simulated by software for providing a common pool of computing resources in a scalable configuration.

The system may also utilize processors located on a terminal and processors located on a remote set of servers; individually or in combination. Various configurations are possible, for example, the user (e.g., authors and content consumers) may access and interact with some content on a mobile device, with the rendering of simulations and calculations to be done remotely on servers and/or physical hardware.

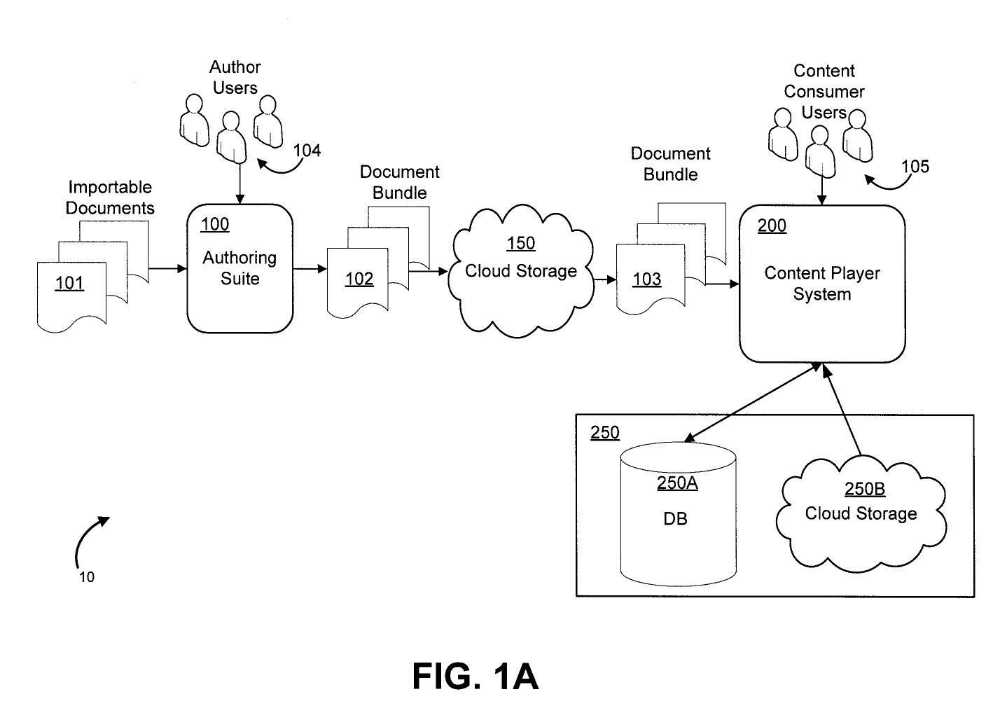

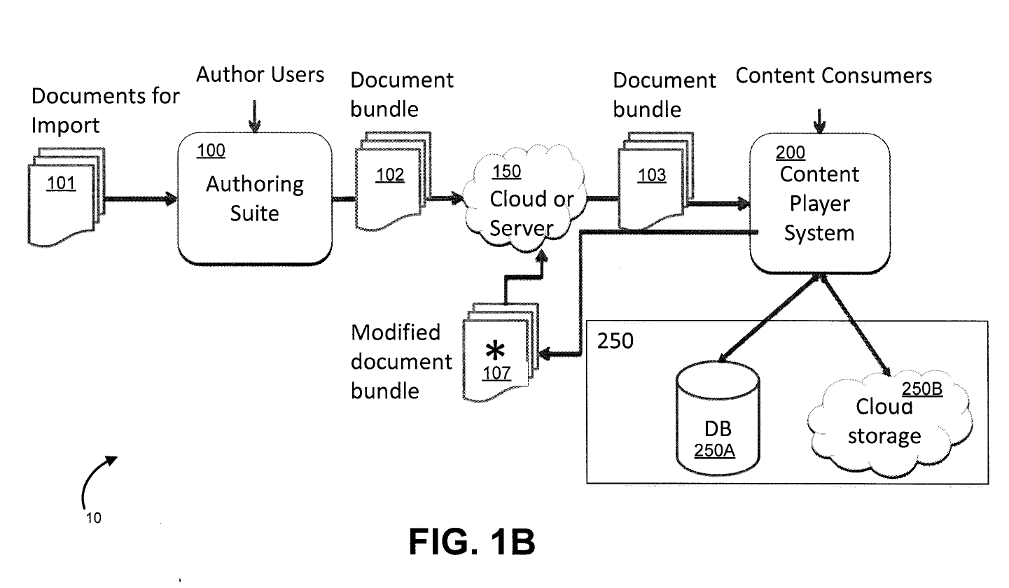

Referring to FIG. 1A, a high level flow chart of the system, according to some embodiments is provided. The system (10) is comprised of an authoring tools subsystem (100), one or more storage devices (150), a content player system (200) and external storage (250).

A computer-implemented system (10) may host and/or otherwise provide a digital content infrastructure on one or more computing devices having one or more processors and one or more non-transitory computer readable media. The authoring unit (e.g., the authoring tools subsystem (100)), may be configured to: receive machine-readable input media from a content author, the machine-readable input media being provided in a platform independent format, pre-process the received machine-readable input media to generate a platform independent document bundle comprised of raw content files, and transmit the platform independent bundle for distribution to one or more content presentation units (e.g., a content player system (200). The content player system (200) may each be configured to: receive the platform independent bundle from the authoring unit; detect or determine device configuration or presentation data for the respective recipient computing device; transform the platform independent document bundle using device configuration or presentation data to generate one or more platform specific bundles configured for use with the respective recipient computing device; and communicate, through a user interface having at least a display, platform specific content based at least on information provided in the platform specific bundle.

The system (10), for example, may be configured to provide a framework that facilitates the development of cross platform applications having various functionality with a potentially reduced time and effort. The system (10) may be adapted such that the overall design centered around two aspects: 1) authors define the semantic content of their app/document including the semantic hierarchy of the application/document in a platform and layout agnostic manner (as opposed to designing specific layouts in a WYSIWYG type manner); and 2) authors can integrate scripting relatively conveniently (e.g., more easily) into aspects of the document, including through UI controls, background events, timers, simulations, communications, and navigation callbacks.

The framework provided by the system may, in some embodiments, be adapted to support more easily creating cross platform applications/documents that, for example, may automatically generate native platform elements and layouts such that authors need not design documents specifically for particular device types (e.g., phones, tablets, portrait vs landscape) or for particular mobile operating systems (e.g., iOS or Android). The system may be designed to be scalable and to more readily facilitate distribution, in particular where resources may be scarce (e.g., network bandwidth, computing power, processing power). The apportioning of steps and/or processes between the various components of a system, such as a backend tool for authoring/deploying content, and a frontend computing device and/or interface may contribute to the amount of resources used. Accordingly, to provide a scalable and potentially more efficient solution, in some embodiments, authoring platform agnostic content may be provided at a backend server level or a computing device with limited resources, and the transforming of the platform agnostic content may be conducted by the platforms actively consuming the content (e.g., user smartphones, tablets, desktop computers).

Integrated scripting language support may be provided to allow authors to develop complex custom behaviors such as programmable interactive components, mathematical computations, multi rate simulations, communications, and dynamic, responsive content.

Using the framework, authors can develop applications, documents, etc., that can be downloaded and executed on iOS and Android devices that use UI elements native to each platform, which greatly reduces the time and effort that would be required to produce such apps using traditional app development tools.

As the published document bundle, in some embodiments, may be in the form a compressed archive of platform independent document content and resources (XML files, images, video, audio, raw binary data, etc.), a document bundle may provide a single source for users (104, 105) (e.g., all users) to download, which may then be then extracted, parsed, and/or rendered by another application (e.g., a mobile application) to produce platform specific, device and/or form factor specific layout of the documentation and/or application. For example, there may be various devices having different form factors but running the same background operating system (e.g., various devices running Android).

According to some embodiments, one or more author users (104) may utilize the authoring tools subsystem (100) to generate content to be consumed at a later time by one or more content consumers (105). Content does not necessarily have to be generated using the authoring tools subsystem (100). The one or more storage devices (150) may store the content, and may be implemented using a variety of technologies, such as hard drives, servers, and/or cloud implementations.

Author users (104) may include individuals authoring and developing content to be consumed, such as individuals who are involved in teaching or an academic setting. For example, a professor of engineering at a university or an individual creating content for a corporate training session could be considered an author user (104).

Content consumers (105) may include individuals who consume content, such as individuals who are receiving instruction or in an academic setting. For example, an engineering student receiving instruction at university could be considered a content consumer (105). The definition is not limited to academic institutions; there may be other situations where this system may be utilized, for example, in corporate training environments.

Content may vary depending on the application, and may include a range of documents such as marketing materials (interactive product information sheets, brochures, catalogues), consumer device interfaces (wireless thermostat, smart home appliances, car diagnostics/control, home theatre, etc.), interactive presentations, etc. Content may also include media, such as audio files, video files, etc. Content may be singular documents, or organized into content bundles (102, 103).

The authoring tools subsystem (100) may be configured to provide one or more author users (104) the ability to develop, maintain and update documents containing various content to be published and deployed on various devices. The content may be created in various formats, including platform independent formats such as extended markup language (XML), and publishing the content may involve bundling with media files (images, audio, video, binary data, csv data) and uploading the bundle to an online repository, cloud or server-based system (150).

Author users (104) may create new content using the authoring tools subsystem (100) as well as import certain supported files/documents (101) into the authoring suite (100) such as plain text, LaTeX files, and MS Word documents. The output of the authoring tools subsystem (100) suite may be a document bundle (102, 103) that contains one or more raw content files (XML content definitions) along with any additional media files (audio, video, images, GIFs, binary data, etc.). The authoring tools subsystem (100) may be configured to enable author users (104) to upload their document bundles (102, 103) to an online cloud (150) and/or database repository (250A).

The authoring tools subsystem (100) and/or the cloud/server system (150) may perform other processing of the content bundle (102) and generate a final content bundle (103) that is the collection of files for a document that is downloadable by the content player (200).

Specific functional elements of the authoring tools subsystem (100) will be described later in this specification at Section 2.1, and may include, in some embodiments, supporting tools, such as integrated development environments, document revision tools, the use and assignment of global unique identifiers (GUIDs), integration with the analytics subsystem (246), the ability to provide and/or define interactions with an object under test, the ability to attach various multimedia content, the ability for the author to customize and/or define sensory inputs and manipulations, etc.

The content player system (200) may be any device where a content consumer user (105) is able to consume content, and may have one or more screens, one of more processors, one or more non-transitory computer readable media, one or more sensors, etc. As an example, a smartphone, a cellular phone, a tablet PC may all be considered as devices that could be used as content player system (200).

Content consumer users (105) can then browse available content through the content player system (200)'s document delivery subsystem's search and download functionalities, connect to the online document bundle repository (250), and download the desired document bundle (102, 103).

The content player system (200) and database (250) may be able to apply permissions and restrictions to documents based on user accounts as well as provide push notifications to users (104, 105) when new documents or updates are available for download.

Once the document is downloaded by the content player system (200) to a content consumer user's (105) device, the content player system (200) may parse and interpret the document's contents and may create the sections, pages, and content to display to the user (105).

In some embodiments, the content player system (200) preprocesses the document bundle (102, 103) for efficient searching and fetching of content elements.

The content consumer user (105) may also be able to modify the document by dynamically adding content in the form of notes, saved data, and annotations (highlights, bookmarks) as well as by changing the state of the documents and its contents (this includes state such as the navigation history, most recently opened section, completed exercises, simulated results, screenshots, and values of controls and input fields).

These state data may be persisted across content player system (200) invocations and across devices by the content player system (200)'s data storage (150, 250) and user account management subsystem (230), which serialize and store this information locally on the device and/or in online database and cloud storage (250) or internal storage (252).

The content player system (200) may also allow content consumer users (105) to store/upload exported reports containing screenshots, notes, and data.

In a specific example, the content player system (200) may be a content presentation unit that is configured to process the platform independent bundle to generate the platform specific bundle by: identifying one or more available features of the recipient computing device, the one or more available features being at least a portion of the device configuration or presentation data; identifying one or more unavailable features of the recipient computing device, the one or more unavailable features being at least a portion of the device configuration or presentation data; transforming the raw content files or the machine readable input media included in the platform independent bundle to associate the raw content files or the machine readable input media with the one or more available features of the recipient computing device; traversing the raw content files or the machine readable input media to determine whether there are any raw content files or the machine readable input media that cannot be provisioned using only the one or more available features of the recipient device; and generating a placeholder object for incorporation the platform specific bundle associated with the raw content files or the machine readable input media to indicate which of the raw content files or the machine readable input media cannot be provisioned using only the one or more available features of the recipient device.

Referring to FIG. 1A, a sample use case is provided, according to some embodiments. In this use case, once a document (bundle) (103) may be downloaded by the content player system (200) to a user's (104, 105) device, the content player system (200) may parse and/or interpret the document contents, and may create various elements (e.g. sections, pages, and/or content) to display to the user (105). The content player system (200) may be configured to preprocess the document bundle (102, 103) for searching and/or fetching of content elements. The content player system (200) subsystems may be described later in this specification.

In some embodiments, the content player system (200) may also be utilized to dynamically create content to author content by adding/removing/modifying content from an existing document and subsequently uploading the modified document (*107) to the one or more storage devices (150), as shown in FIG. 1B.

In some embodiments, a content consumer user (105) can begin either by downloading an existing editable document or creating a new document. Then, with the content player system (200) the content consumer users (105) may be able to modify the document's content. The new document can be then uploaded directly from the content player system (200) to the one or more storage devices (150). The content player system (200) may contain facilities to create the cross-platform document bundles (102, 103).

This process can be used for various purposes, such as: (a) allowing an author to adjust/edit their own original document allowing them to make updates after publishing it to the cloud (150, 250B) (e.g. the author can impose edit permissions such that they alone have editing capabilities for their document), (b) content consumer users (105) can create documents or modify editable documents directly from the content player system (200) without needing to use the authoring suite, and (c) multiple users (104, 105) can collectively edit shared documents in a collaborative manner. The authors (104) may, in the course of develop documents that are published for distribution/use.

Publishing, for example, of documents may include various processes and steps. An example is provided where the system (10) facilitates single click publishing by automatically bundling a document (101) with resources and processing the document references to eliminate unused resources (e.g., images). Various themes may be applied to the document.

The authoring tool (100) may be configured to provide a seamless publishing application workflow which may include various steps. For example, an author may develops a XML-based document/cross platform knowledge application along with integrated Lua scripts, and when the author (104) is ready to preview the document/cross platform knowledge application on a physical device (e.g. iOS/Android phone/tablet), authors may utilize a single click publish button which performs the following steps:
Packaging & Submission
Pre-processing of Bundle
Validation of Bundle
Processing of Bundle
Post processing of Bundle

Back-end services may be geographically positioned to reduce the overall latency between the authoring tool and services through the use of cloud based systems (i.e., Microsoft Azure™, Amazon S3™)

While various details of the publishing workflow are provided below in greater detail, one central aspect of the framework includes:
A user (104) authors a document/knowledge application using a cross platform XML-based language.
After using the single-click publish button in the authoring tool (100), the document/knowledge app goes through the publishing app workflow as described below in seconds.
When the final processed document is loaded on an iOS or Android mobile device seconds later, the cross-platform XML-based source code is used to dynamically generate native UI components and wire up the scripting logic dynamically on the executing platform.
The overall speed of going from cross-platform XML code into a natively executing application through the framework is advantageously provided and an innovative aspect of the platform.

Traditional approaches to application development require knowledge of platform-specific APIs, platform-specific programming languages and going through application review process, etc.
The authoring framework (100), through at least its configuration in some embodiments, reduces the development time of native application logic significantly (e.g., from an order of months into seconds).

Accordingly, in various embodiments, several features may be provided, such as, but not limited to:
(a) an authoring/content consuming system;
(b) the ability to dynamically define interfaces;
(c) globally unique identifiers (GUIDs) for content;
(d) algebraic loop handling;
(e) multi-rate simulations;
(f) multi-peer data streaming;
(g) collaboration/social networking;
(h) near real-time or real-time document linking
(i) 2D/3D interface and gesture definition
(j) augmented reality overlays
(k) gesture application programming interfaces (APIs)
(l) hardware abstraction layer

Each of these features will be discussed in further detail under Section 2.

### 1.2 Content Player

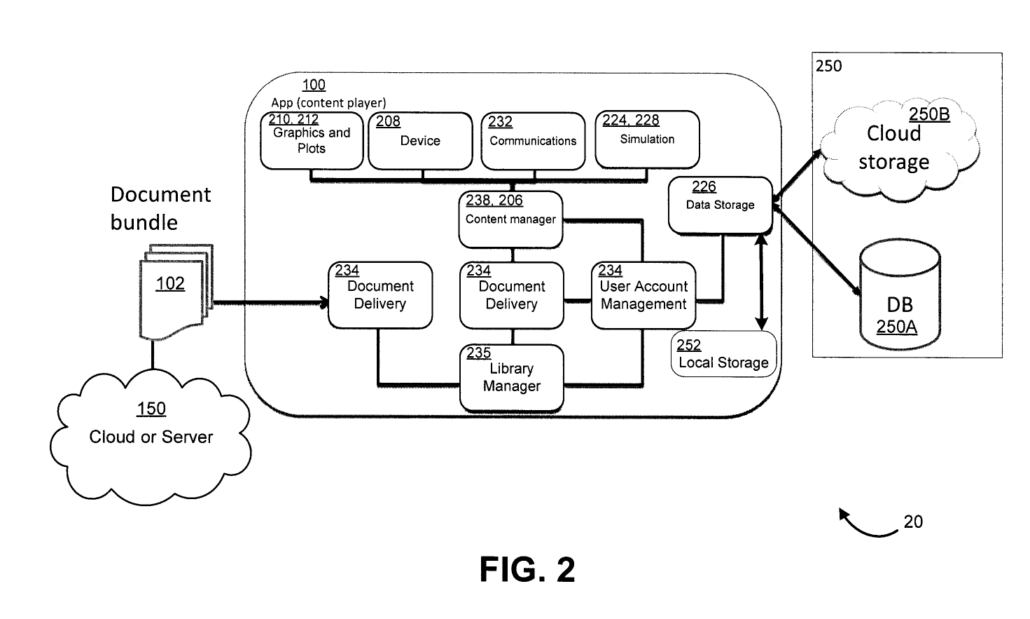

Referring to FIG. 2, an example schematic providing a block diagram of the architecture of a content player system (200) is provided, according to some embodiments. This schematic illustrates the various interconnections that may exist between various subsystems.

Referring to FIG. 3, a block diagram of the architecture of the content player system (200) is provided, showing an expanded list of subsystems, according to some embodiments.

This section introduces a number of subsystems that the content player system (200) may be comprised of. The subsystems and their descriptions are provided solely for illustration and should be understood as non-limiting examples of some embodiments. The subsystems may be implemented in various ways, various subsystems may be added, omitted, modified, and/or combined.

The content player system (200) may operate in conjunction with one or more objects under test (300).

The content player system (200) may be comprised of a number of subsystems; including a native UI abstraction subsystem (206); a gestures/sensors/device subsystem (208); a plotting/2D line drawing subsystem (210); a 2D/3D graphics and animation subsystem (212); a plot analysis tools subsystem (214); an equation rendering subsystem (216); a content generation and layout subsystem (218); a content language definition/parsing subsystem (220); a content navigation subsystem (222); a simulation and solver tools subsystem (224); a data collection/storage subsystem (226); a timing tools subsystem (228); a user account management subsystem (230); a communications subsystem (232); a library and document delivery subsystem (234); an image processing subsystem (236); a digital signal processing subsystem (240); an expression evaluation subsystem (242), an API/service consumer subsystem (244), an analytics subsystem (246), a local storage subsystem (252), and one or more online and/or external storage systems (250).

The storage devices (250) and/or (252) may be comprised of various types of non-transitory computer readable storage media, and may store information or metadata relevant to the system (200) and/or user information relevant to the authors (104) and content consumers (105). The storage devices (250) and/or (252) may also provide a content repository that stores various content, such as user notes, annotations, bookmarks, usage details of content, and/or relationships and associations between various elements of created content. Information may be stored on a user-specific basis, wherein the state of the content elements may change as a user (104, 105) conducts various activities with the system or the content.

In some embodiments, the internal storage devices (252) and/or external storage devices (250) may be comprised of cloud-based distributed networking resources.

In some embodiments, the storage devices (250) and/or (252) may also support searching for user created elements such as notes, annotations, bookmarks, etc. In some embodiments, the information may be searchable and/or other subsystems may be configured to interoperate with the storage devices (250) and/or (252) to perform searching.

The storage devices (250) and/or (252) may be implemented using various technologies, such as physical hard drives, solid state drives, in random access memory (RAM), in read-only memory (ROM), flash memory, magnetic tapes, virtual drives, etc. The storage devices (250) and/or (252) may also utilize various formats for storage, such as relational databases, flat files, cloud storage/cloud services etc.

A content player system (200) may provide an interface for a content consumer (105) to consume content. The content player system (200) may be implemented on a variety of devices, each with a variety of capabilities and interaction technologies.

The content player system (200) may be able to identify functional capabilities of the device and available sensors.

In some embodiments, the content player system (200) is an application designed to operate natively on a platform. These platforms may include various tablets, mobile devices, desktop computers, etc. For example, if implemented on mobile devices, the application may be a mobile application. The content player system (200) may be configured to utilize functionality present on a platform, such as, for example, sending/receiving push notifications.

The content player system (200) may include capabilities such as communications protocols for streaming video, content delivery, and real-time interaction with external hardware, a hardware accelerated rendering engine to provide 3D graphics, real-time plotting, and the display of the theory and mathematics, a simulation engine to execute simulations designed for each content module with real-time user interaction.

In some embodiments, the content player system (200) may be configured to provide indications of use to the analytics subsystem (246), including various statistics regarding the interaction with content published by various authors (104).

As shown in FIG. 2, the various subsystems may be interconnected to one another and the storage devices (250). Other interconnections may be possible and all interconnections illustrated are provided only by way of example, according to some embodiments.

The native user interface (UI) subsystem (206) is a subsystem that may be configured to transform platform independent elements to platform specific elements. The native UI abstraction subsystem (206) may have libraries of virtual objects and their properties. These libraries may include information indicating the association between various virtual objects, especially information associating platform-independent and platform-specific elements. For example, a platform-independent element may have various platform-specific elements associated with it, and the native UI abstraction subsystem (206) may be configured to translate or transform elements.

The native user interface (UI) subsystem (206) may contain a collection of content elements abstracted from platform-specific elements to platform-independent objects, including, for example, objects representing platform-independent wrappers of a specific view object native to each platform.

Common styling functionality may be utilized across platform-independent objects. Where appropriate, certain platform-independent objects may share code across platform-specific implementations. Each platform-independent object may be created using platform independent parameters (such as default string, formatting options, etc.) and subsequently instantiate platform-specific views and applying appropriate styling.

The gestures/sensors/device subsystem (208) may be configured as an application programmable interface (API) that abstracts gesture/touch events as well as device sensor feedback (e.g. accelerometer, gyroscope, magnetometer, battery level, audio input, etc) for use in the application. Other add-on sensors that interface with the player device, including but not limited to wearable sensors such as heart rate monitors, may also be accessible through the gestures/sensors/device subsystem (208). The gestures/sensors/device subsystem (208) may, in some embodiments, be utilized for providing augmented reality features in conjunction with the other subsystems.

For example, a content consumer (105) may be able to view an object in test with the system overlaying information related to various information about the object in test. In such an example, the camera on a device may be utilized to provide a video feed to the gestures/sensors/device subsystem (208). The information may be measured and/or simulated data.

Depending on the particular device used by a user (104, 105) as a user's terminal (e.g. mobile device, laptop, tablet), there may be a number of sensors on board that may be accessed for use by the application. These sensors may be contained within the device, attached to the device or otherwise accessible by the device, for example, sensors such as accelerometers, gyroscopes, magnetometers, battery level indicators, microphones/audio input, global positioning system (GPS) locators, wireless, cameras, near field communications devices, proximity sensors, hardware testing apparatuses, etc.

The gestures/sensors/device subsystem (208) may be configured to wrap specific device API functions for gesture recognition and sensor measurement in a platform-independent interface. This may be advantageous for delivering an interactive and engaging experience to the content consumers. These gestures may be mapped to customizable functions, and a library of gesture types may be provided (e.g. swipe across the top, swipe in a ‘Z’ shape).

The API functions may be utilized to perform various functions such as starting and stopping simulations and plots, resizing, panning and manipulating views (e.g., plots, images), navigating through documents, for using advanced custom gesture features, and for using the analysis tools built into the plotting subsystem, among others.

The plotting/2D line drawing subsystem (210) may be configured to provide various plots and graphs for various uses, which may include, for example, being used to demonstrate theoretical concepts, equations and systems, to study simulations of system models, to perform pre-laboratory exercises by changing system parameters (tuning) and observing the change in the simulated response in real time, to design systems through real time parameter tuning, to display feedback from objects in test (through wired or wireless connectivity), to display the results of hybrid systems where real hardware systems' output is connected to one or more simulated systems, and to perform analysis using tools in the plot for all of these activities.

Developing these plots may require a significant amount of processor resources. A 2D/3D graphics and animation subsystem (212) may be utilized to provide graphics rendering capabilities.

Various implementations are possible, including the use of OpenTK as a C# implementation of OpenGL used for rendering graphics. A potential advantage of using an implementation such as OpenTK is the ability to consolidate many of the graphics features in a common code base.

Other tools and techniques may be used, including those designed to be cross-platform and utilize a common codebase for rendering the plots.

In other embodiments, plots may also be developed using platform specific vector drawing utilities, which requires specific implementation on each platform.

In some embodiments, the processing of information required to generate a plot may be conducted on an application at a user's terminal, or at a backend system, individually or in combination.

The plot analysis tools subsystem (214) may be configured to allow users (104, 105) to analyze and manipulate data displayed on the plots in various ways. Analysis features may include those similar to features on an oscilloscope (e.g., range, peak-to-peak measurements, cursors) but may also be implemented to allow the user (104, 105) to use touch gestures to perform analysis on the data sets or data points.

The user's (104, 105) analytical capabilities may include manipulating the plot's scaling and positioning to view specific points in the plot. For example, this capability could be used to view a specific point in an experiment's history.

The plot analysis tools subsystem (214) may interface with the gestures/sensors/device subsystem (208) to provide interactions that may utilize the on-board sensors and gesture interfaces as inputs or outputs to the system (10). For example, a user (104, 105) may be able to interact with various plots via touch, or in some embodiments, customized gestures that may be customized by an author user (104) when authoring content.

In some embodiments, an author user (104) is able to indicate touch regions on a particular plot where gestures can be utilized.

Various other interface capabilities may be supported. For example, when a user (104, 105) holds a touch input (e.g. long-pressing) on the plot, the plot analysis tools subsystem (214) finds the closest point on any curve in the plot and inserts a data cursor at that point, which displays the (x, y) value of that point. The data cursor may be attached to the curve and can be dragged with a single finger touch to any point along the visible curve and updates the display to show the current value of points along the curve.

The analysis tools may also allow content consumers to export screenshots and specific data points and measurements to a notes or report section, which can be used to export that information to a file that can be downloaded for various purposes, including reporting or further offline analysis.

The equation rendering subsystem (216) may be configured for converting text-based mathematic expressions or other types of inputs to a graphical equation representation. For example, mathematical expressions are often expressed in various typesetting systems and document mark-up languages, such as LaTeX or Mathematical Markup Language (MathML).

Support for rendering mathematical equations is a potentially advantageous feature, especially for those users (104, 105) in an academic or highly scientific setting. In some embodiments, the equation rendering subsystem (216) converts text-based math equations from various typesetting systems or text formats, which may include LaTeX (or MathML) using views or applications that may be native to various mobile operating systems.

The equation rendering subsystem (216) may be configured to function either or both off-line and on-line.

In off-line implementations, an author (104) may be able to render equations using the processors and libraries stored on the author's terminal or device. In some embodiments, an author's (104) terminal or device may be configured to utilize a subset of various software packages on their mobile device to render equations locally. There may be a number of software packages available for use in rendering equations. For example, the MathJax source may be downloaded and customized to install a subset of the full implementation in the mobile application itself so that an author (104) may use MathJax locally in the application rather than rely on a connection with a server.

In on-line implementations, an external server may be accessed through various means, such as a web-based utility (e.g. MathJax), to send the source math expression to a server, which then returns an image showing the typeset math equation. An example implementation of this may be written in JavaScript and executed for use with a web client.

The equation rendering subsystem (216) may be configured in various ways to render mathematic equations. For example, the equation rendering subsystem (216) may be configured to render each math expression sequentially after parsing the input content string and extracting the mathematical expressions that require rendering, then capturing each rendered math expression as an image and finally placing the image of the rendered math expression inline in a view object that may be native to a particular terminal or device. However, it may be found that this implementation may have issues with processing speed as mathematical expression may be individually processed, converted to an image, cropped, and typeset inline in the appropriate position. The process may also produce typesettings of diminished quality of as the math expression is rendered independently from the text in which it is located and then simply placed at the appropriate location in the text with some resizing done to adjust it to fit the line height.

In some embodiments, the equation rendering subsystem (216) is configured for preprocessing the mathematical equation offline and rendering images a priori on either the author's development system and/or backend servers, which then take the generated image and add it to the content bundle (source content files and media files) and alters the content source to reference the equation's image in the appropriate location.

In some embodiments, the equation rendering subsystem (216) utilizes a customized LaTeX or MathML (or other math description syntax) rendering system, which can be used to render math expressions in a cross-platform library and generate the rendered images for various platform.

In some embodiments, the XML files in the document bundle may contain structured content as well as structured code elements and semantic references between content and code elements, which may be in accordance with a schema that defines the content language.

The content generation and layout subsystem (218) may be configured to generate the pages and views on the application screens from the source content files. In some embodiments, the source content files are provided in XML.

The content generation and layout subsystem (218) may define each screen as the section and pages may be loaded by the application's content manager subsystem (238), which may be responsible for parsing and interpreting the source content and supplying the content object instances.

The content manager subsystem (238) may also be responsible for parsing, interpreting the source content and/or generating the semantic links and connections between document elements, which may include content elements and/or code elements.

In some embodiments, the content manager system (238) may be configured for generating descriptor maps from downloaded content from an online repository system. A state manager may be configured for pushing content to an external repository, such as a cloud-based repository, and descriptor maps may be created from the content. The descriptor maps, in conjunction with the GUIDs, may be used specifically to optimize the system so that parsing the document is significantly faster once the document has been “processed” by the content manager module (238) for the first time. Such functionality may be advantageous for platforms where there are constraints on memory, battery and/or processing power, as it is more efficient and may be less costly in terms of computational power and/or memory usage.

The content generation and layout subsystem (218) may be configured to create platform-specific view implementations that utilize the necessary view objects (e.g., buttons, sliders, text fields, images, etc) as the content manager interprets the content source at runtime.

Pages may be created using platform-specific vertically scrolling views so to allow a number of view elements to be added to pages without restricting the page's length. The pages may then add the content views to their scroll views and resize the scrolling view vertically to accommodate the content.

Each page may then be added to a paging view that allows users (104, 105) to swipe between pages horizontally like a book. Content types, pages, and paging views may be abstracted as platform-independent objects to facilitate creation and manipulation.

The content language definition/parsing subsystem (220) may be configured for the parsing and rendering of source content to create content to be provided into the system (10). The content language definition/parsing subsystem (220) may be configured in various ways, including using XML language schema to define the XML elements attributes, and hierarchy as well as to validate and parse the content files.

In some embodiments, the schemas may be developed to leverage existing tools to aid in creating the content either manually/directly or through authoring tools, to allow for the use of existing tools for processing, searching, and parsing of the document, and to allow the system (10) to be scalable for adding new content types and features.

The content navigation subsystem (222) may be configured to provide users (104) and authors (104) a convenient method to navigate through various information and content provided by the system (10), such as curriculum, additional information, external links, and interactive experiments.

The content navigation subsystem (222) may be configured to parse a document's content to allow users (105) to navigate through the document's pages, sections, user (105) and author (104) defined bookmarks, intra- and inter-document links, as well as search through content for keys, tags and references for the purpose of navigation and/or content previewing and display in a popover, callout, or dialog.

The content navigation subsystem (222) may interact with the content manager subsystem (238) for content searching and lookup as the content manager subsystem (238) may include stored content that may be referenced.

The content manager subsystem (238) may also maintain a library of document sections and subsections to allow the content navigation subsystem (222) to request content metadata and/or loading of specific content or content sections.

The content navigation subsystem (222) may also be configured to maintain a history of the user's (104, 105) navigation so that users (104, 105) may view and navigate through sections that have been previously loaded or accessed. The content navigation subsystem (222) may further be configured to display a “tree view” of the document's contents to allow users (104, 105) to traverse the document sections, pages, figures, etc.

The simulation and solver tools subsystem (224) may be configured to provide a simulation and dynamics framework that defines models, their interconnections, and the simulation environment in which they are simulated.

Systems, in the context of the simulation and solver tools subsystem (224), are components that have some number of inputs, outputs, and state as well as connectivity to “workspace parameters”. Systems have parameters specific to the type of system and are assigned to a solver, which determines the rate at which the system is evaluated and how the system is evaluated throughout the simulation time (fixed time step solver vs. variable time step solver).

A solver is a mechanism by which a collection of systems are evaluated at a specified synchronous rate or asynchronously. Each solver in the simulation has a rate and is triggered by the simulation engine when it is supposed to execute.

The simulation and solver tools subsystem (224) may be configured to provide several features, such as the ability to automatically resolve algebraic loops and also the ability to handle rate transitions. The simulation and solver tools subsystem may be configured to allow for the simulation of various types of mathematical, virtual and/or physical systems. For example, a physical system may be represented as a model having one or more algebraic feedback loops, and may be solved by iteratively conducting mathematical operations. Systems to be solved may be, for example, control systems having one or more feedback loops, linear systems, non-linear systems, mathematical models of physical phenomena, etc.

For example, systems may be various types of dynamic systems represented by ordinary differential equations (ODEs), such as physical systems (utilizing various models of physics, such as Newtonian), financial systems, biological systems, control systems, electromagnetic systems, electromechanical systems, mechanical systems, etc. The solver module may be capable of solving equations for simulations in a wide range of fields.

In some embodiments, the system is not only capable of obtaining a solution for systems which contain a closed form solution, but it can also be used to generate systems capable of solving a set of equations (or expressions) using iterative computations to converge to a solution (i.e. using the Newton-Raphson Method).

The simulations may be configured to operate with plotting functionality such that a (104, 105) user may be able to observe the effects on plotted information, and in some embodiments, the simulation may permit for real-time modification of parameters, using, for example, various sliders, switches, gestures, and/or numeric input fields. In some embodiments, the plots may also be configured to automatically scale during simulation of a system. For example, such functionality may be helpful where the numerical values grow beyond the limits of the current axes, or in the converse scenario, where the numerical values are so small such that it may be difficult for a user (104, 105) to discern information from the plot. Interaction in the plotting module (210) may also interact with the one or more solver tool modules (224), and vice versa, such that behavior of the system may be adjusted.

One or more expression evaluator modules (242) can also interact with one or more solver tool modules (244). Furthermore, the system may be configured such that interaction in the expression evaluator module can adjust the behavior of the mathematical system in the solver module (and vice versa). The functionality may be useful for enabling the adjustment of mathematical system behavior in a dynamic manner responsive to interactions related to mathematical expressions. For example, a content consumer may wish to observe how modifications of co-efficients of a mathematical express impact the solving and/or simulation of a mathematical system in real-time.

Simulations may be conducted based on various timing parameters, which may be in real time, in some embodiments, or simulated at a pre-determined or user-selected rate. For example, an author may specify that a simulation be run as fast as a processing capability of the device allows. In some embodiments, a simulation may be conducted in real-time so that a user (104, 105) can observe how the simulation responds in actual time.

Further, the simulations may be configured such that they are run for a particular duration, or to continue without any fixed duration.

A consideration when using simulations to solve systems may be whether the system converges towards a solution. Where a system does not converge towards a solution, the simulation may have to be interrupted.

While a user (104, 105) may manually insert unit delays into models to help set points for interrupting the simulation, in some embodiments, the simulation may be configured for the automatic detection of algebraic loops and optionally allow the loop to attempt to be solved iteratively (until it converges or fails to converge) or split the loop by detecting a loop breaking point that may maximize the number of loops that are broken, thereby minimizing the number of unit delays in the system required to break the loop without requiring the user (104, 105) to manually insert unit delays in their models.

The simulation and solver tools subsystem (224) may be linked to the timing tools subsystem (228) for controlling the timing of the simulation solvers and for controlling the rates at which the simulation systems are executed.

Systems (10) may be defined by their parameters and the output to a system (10) is defined by its parameters, the system's inputs, the system's state, and the simulation time. Systems (10) have inputs defined by reference to other systems and/or parameters. Simulation parameters (or “workspace parameters”) are values (numeric or non-numeric data) that are globally accessible within the simulation environment and, in some embodiments; they are accessible outside the simulation environment, for example to allow external user control of parameter values to change the model.

A model is the collection of systems (10) executed in a simulation and may be processed across various solvers and varying time steps.

A simulation of a model using more than one rate is a multi-rate model and the simulation framework may be responsible for ensuring that data can be passed between systems (10) running at different rates.

The simulation and solver tools subsystem (224) may be linked to the timing tools subsystem (228) to be configured such that systems can be easily connected to each other regardless of their intended sample rate (even connections between synchronous systems and asynchronous systems). When a system is assigned to a solver, the solver may be configured to determine the rate at which the system is executed. The simulation engine, during initialization, may traverse the graph structure of the model (directed, cyclic graph of connected systems) and may be configured to automatically handle connections between systems running at different rates by inserting rate-transition parameters to synchronize signal flow across these systems in a deterministic manner. As with the algebraic loop handling, these transitions do not need to be handled by the author since the system may be configured to automatically resolve them.

The simulation framework also provides various primitive systems that can be used to construct models that describe theoretical and/or electromechanical systems.

The primitive systems may be predefined constructs that are the building blocks that authors can use to construct more complex models. Primitive systems may include the following systems: constant, gain, product, saturation, signal selector, sine wave, square wave, state-space system, transfer function, mathematical expression, subtract, and sum, among others.

The simulation and solver tools subsystem (224) may be configured to allow asynchronous access to the simulation workspace parameters, which allows parameters to be read and written to asynchronously. Asynchronous access may allow for the changing of model parameters at runtime and for storing the system/model outputs for plotting, display, and/or storage for the user (104, 105). Asynchronous access may be helpful for a content consumer to vary model parameters in a convenient fashion, and to store these values for future simulations.

The basic mechanism for interfacing with a simulation may be through the simulation's parameters. The parameters may provide means to connect data going into and out of the simulation to any number of different subsystems in the content player system (100) including: communications, gestures, sliders and other input controls, displays, plots, stored data, etc.

The data collection/storage subsystem (226) may be configured to facilitate collecting and storing data in the application, which can be data generated from a simulation and/or communication stream.

This subsystem may be utilized to allow data storage to be decoupled from the data sources in an implementation so that it is configured to facilitate the collection of data, plotting/display of data, and saving data in storage or for exporting data.

In some embodiments, the data collection/storage subsystem (226) may be configured for saving and loading content state specific to a user (104, 105). This is used not only to preserve document/content state across invocations but also across devices using online/cloud-based storage.

In some embodiments, the data collection/storage subsystem (226) may be configured for saving collected data, such as state information. This information may be utilized by the content player system (100) to load information in advance of the information currently being displayed, so that a page's content elements and their state information are pre-loaded before the page is displayed. Similarly, the content player system (100) may be configured to specify the point at which pages and their contents are unloaded once the user (104, 105) navigates away from the page. These lifecycle management activities may be performed by a page controller which may be part of the navigation manager subsystem (222).

The timing tools subsystem (228) may be configured for providing an abstracted set of timing functions used in plotting, communication, and in simulation. The abstracted set of timing functions may permit the reuse of functionality across subsystems as well as the ability to synchronize them when needed.

The user account management subsystem (230) may store user information (e.g. content progress, stored data, simulation results, bookmarks, and downloaded content).

The user account management subsystem (230) may be configured to manage each user's account in the application. This feature is potentially useful for synchronization of document state and data across devices for the user (104, 105), e.g., the user saves bookmarks and adds notes throughout a document on one device and when the user changes to a different device and logs in using their user account, the user account management subsystem (230) will synchronize with the latest data in the cloud to restore their saved notes, bookmarks, and document progress on the new device, which may be saved on the data collection/storage subsystem (226). This subsystem may use cloud-based approaches to maintain a consistent set of the user's (104, 105) data and states across devices. The subsystem can also be used to notify the user (104, 105) of updates to documents, provide privileges to access protected documents, etc.

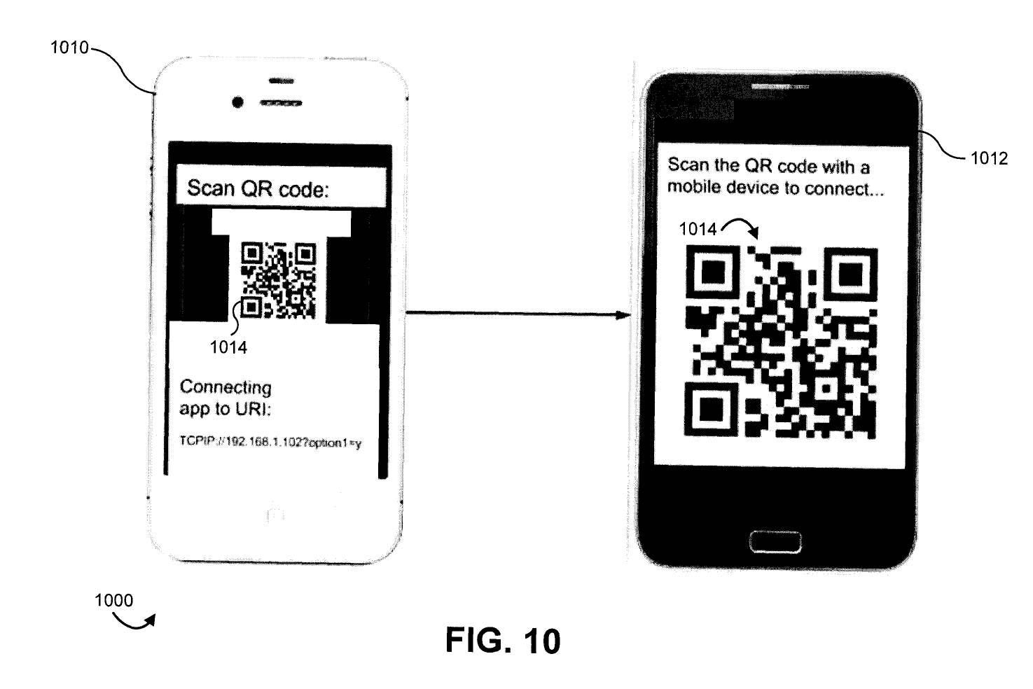

Communications subsystem (232) may be configured for streaming external data from objects under test (300) and for downloading simulation results for reporting purposes. The communications subsystem (232) may be used to abstract wireless and/or wired communication services. The communications subsystem (232) may utilize various connection types, including wired and wireless communications types, such as physical connections via various cables, wireless connections through Bluetooth™, wifi, Near Field Communication (NFC), etc. In some embodiments, the content player system (200) may be configured to provide functionality to authors (104) and/or content consumers (105) to connect wirelessly to a URI (Uniform Resource Identifier), a stream which connects to a channel and accepts incoming client connection requests. An example connection between two devices using a QR code to transfer URIs is provided at FIG. 10. The stream can be used to stream measurement data as well as transmit commands from an interface, allowing users (104, 105) to interact in real or near-real time with a system (10) while at the same time utilizing the system's (10) plotting and analysis tools for various measurements.

In some embodiments, simulations can be performed simultaneously with input from a separate device or experiment to allow users (104, 105) to compare simulation results with real systems in real or near real time.

The communications subsystem (232) may also be used for direct communication between devices, allowing users (104, 105) to collaboratively share content and work together.

The communications subsystem (232) can also be used to transmit partial documents in order to define remote interfaces dynamically between an object under test (300) and the content player device.

The expression evaluator module (242) may be configured to solve mathematical expressions. The expression evaluator module (242) may include subsystems which employ various means to solve expressions, such as approximations, conducting various substitutions, numerical computation, conducting mathematical operations, iteratively solving systems, etc. The expression evaluator module (242) may be configured to detect and/or identify variables and/or constants/co-efficients.

The expressions may contain any sequence of linear and non-linear mathematical operations (e.g. trigonometric functions, logarithmic functions, etc may be supported in various configuration). The expression evaluator module (242) may be configured to systematically deconstruct the expression and determine the correct order of operations to execute and determine the solution to the expression.

The expression evaluator module (242) can also be setup in a triggered mode where an event (i.e. the start of a new time step in simulation running with a solver module) triggers the execution of the expression evaluator. The expression evaluator module (242) then calculates the solution to its own expression using parameters in the solver module and returns its solution to the solver module to continue the solver's execution.

Multiple expression evaluator modules (242) can work with each other. Furthermore, expression evaluator modules can be nested amongst themselves. For example, if expression evaluator module 1 is solving e₁=sin (e₂) and expression module 2 is solving e₂=e₃²+5e₃ and expression module 3 is simply e₃=2, the expression evaluator modules (242) may be configured to automatically determine the correct order of execution and ultimately solve the nested expressions for the solution e₁=sin (2²+5²).

The one or more expression evaluator modules (242) can be included in one or more solver modules (224) as “blocks” in a signal-flow diagram. In some embodiments, the expression evaluator modules (242) can be executed internally within the context of a solver module and/or they can be executed externally and have their solutions transferred back indirectly through parameters.

The analytics subsystem (246) may collect statistical information from various devices for various purposes, including usability analysis, data mining, advertising, etc.

For example, the analytics subsystem (246) may be utilized to determine trends on how authors and/or content consumers author/consume digital content. Metrics may be set and tracked based on audience, demographics, technology, connection type, navigation flow, content, bounce rates, content, performance (page/section load times), crash reports, categories, keyword analysis, searches, etc. The analytics subsystem (246) may also be used to provide data or services used for grading and/or verification and/or plagiarism detection.

In some embodiments, the content manager subsystem (238) may be configured for convenient and quick searching, and may also include the capture and analysis of metadata and tagging for various types and sections of content.

### 2.0 System Functionality

The following sections describe functionality that is provided by the authoring tools (100) and the content player system (200), according to some embodiments. The sections are provided solely as non-limiting examples, and it may be understood that the functionality may be implemented differently, there may be more functionality, less functionality, etc.

### 2.1 Authoring/Consuming System

The authoring tools subsystem (100) may be configured to provide one or more authors the ability to develop, maintain and update documents containing various content to be published and deployed on various devices. The content may be created in various formats, including platform independent formats such as extended markup language (XML), and publishing the content may involve bundling with media files (images, audio, video) to an online repository.

In some embodiments, the authoring tools subsystem (100) also provides a set of supporting tools, such as integrated development environment (IDE) plugins to aid subsystem designers (e.g., auto-complete, syntax highlighting).

The authoring tools subsystem (100) may be implemented on a variety of different devices and operating systems. For example, the authoring tools subsystem bundle may be implemented on a desktop computer running Microsoft Windows™.

The authoring tools subsystem (100) may be configured to permit the author users (104) to restrict permissions of users (104, 105) who may download their content, for example, to allow only the students registered in a course to download the document(s). Document restrictions may be implemented in various ways, some non-limiting examples include an author selectable password or the author being able to select specific registered user names or identities that have read privileges for the document. Similarly, the author may restrict write access to a document for editable documents.

In some embodiments, the authoring tools subsystem (100) may be linked to the user account management subsystem (230), for the administration and management of user accounts linked to both authors and content consumers. For example, an author may be able to save work-in-progress content pages to his/her account and may also check to verify what has already been published.

The authoring tools subsystem (100) may also provide document revision tools that may be configured to enable content consumers to be able to download revised documents and not lose all of their user-specific state information (highlights, notes, input values, results, etc).

In some embodiments, the authoring tools system (100) assigns global unique identifiers (GUIDs) to all document elements and content, which allows the content and elements to be revised/moved while maintaining the link to users' (104, 105) state information across revisions.

In some embodiments, the authoring tools subsystem (100) may be linked to the analytics subsystem (246) so that an author is able to view a set of analytics results based upon the consumption of authored content. For example, an author may be able to view that content consumers spent most of their time on chapters 1 and 2, but not 3, or that the majority of content consumers did use the interactive plotting and simulation tools that the author had provided to teach a certain concept.

In some embodiments, the authoring tools subsystem (100) may be configured to utilize a mobile application content language that defines the content elements, their data, metadata, and associations independent of platform.

The authoring tools subsystem (100) may be implemented in various ways and in various combinations of ways in providing an author the ability to author content. An author, according to some embodiments, may be able to develop content by writing code, by importing in files stored externally to the system, by importing in objects stored in a local repository, and/or by using various editors, by using various graphical user interface (GUI) editors, layout engines, etc.

The authoring tools subsystem (100) may be configured to allow the author to attach multimedia content (e.g. photos, videos, sound), render mathematical equations, or indicate that a particular equation or concept could be simulated and/or carried out on a hardware testing object. The authoring tools (100) may also be utilized to provide various plots or graphics to further illustrate a concept.

In some embodiments, the authoring tools (100) may refer to one or more objects in test and indicate how a content consumer user (105) would be able to interact with the objects in test to simulate or physically test particular concepts.

The authoring tools (100) may also be utilized to indicate and develop interactivity that utilizes interactive functions inherent in a mobile device. For example, the author user (104) may develop content where a content consumer may be able to interact with the content by using various gestures, such as rotating various objects, pinching objects, rotating the device, tilting the device, etc. In some embodiments, the gestures can be mapped to author-defined functions. In some embodiments, the authoring tools (100) may also be configured to provide one or more authors the ability to customize and/or define the workflow for user interface interactions, for example, a content consumer may first have to drag an object, then move a slider, then tilt the screen, etc. The definition of workflows may be advantageous in providing functionality to help guide a content consumer step by step through various content, for example, where the content consumer is a student and specific guidance is instructive.

In some embodiments, an integrated scripting language may be utilized by the authoring tools (100). For example, NLua auto generated script may be utilized for various purposes, and may help with ease of use (e.g., in relation to local variables).

An aspect that framework that may enable authors to customize behaviors and include programming logic into their documents is the integrated scripting language. NLua, for example, is an implementation of the Lua scripting language for C#. NLua provides a lightweight scripting language that may be dynamically typed, easy for most authors to learn and powerful enough to allow users (104, 105) to add powerful scripted functionality to their documents.

Scripting in the framework may be adapted to allow users (104, 105) to access elements of their documents directly in script using standard scoping rules according to the semantic hierarchy of the document as written in the document XML file. i.e., authors can give names to elements in their document and form local or absolute references to these elements using their names (e.g., myDocument.mySection.myButton). The ability to access elements directly in the script may be possible as the framework parser may be configured to auto generate local script variables corresponding to both the absolute name of each element (e.g., myDocument.mySection.myButton) as well as relative and local names (e.g. mySection.myButton and myButton). These local variables can be used directly in script to read and write values of the document content models. This is advantageous, as authors only need to provide names to elements within their document and the corresponding variables will automatically be available in script. The locally-scoped variables (e.g., myButton) may be useful since the variables may allow authors to encapsulate their content and scripting in a block and since the script references the content in a relative manner, the block can be transposed to another section of the document and still function as expected.

The parser may also support a more efficient mechanism of autogenerating Lua script variables for document references by parsing the Lua script and only generating variables for those elements that are referenced, rather than generating Lua script variables for each named element. In addition to the scoping of local variables based on the document hierarchy, the parser can add additional scoping levels to distinguish between two elements (e.g., styles) with the same name at the same hierarchical level.

For example, a document section may define a style called “style1” then use/reference that style, then later in the same section it may redefine “style1” in the same section and reference it again.

The references between the first definition of “style1” and the second definition of “style1” will use the first “style1”, whereas references to “style1” after the second definition of “style1” will use the second “style1”. The references may provide a natural and easy way of writing since the references resolve in a “top-down” manner.

Such an approach may be implemented through inserting additional scoping levels to differentiate between the first and second definitions of “style1” rather than overriding “style1” when the parser processes the same named element in the same document hierarchy.

Document elements may be assigned GUIDs to uniquely identify them. This may be leveraged, for example, in the scripting environment by utilizing the parser to create global Lua variables for each element using the GUID. This allows users (104, 105) to globally reference any element and also allows the framework to programmatically add script for accessing any element using its GUID.

NLua works by providing a mechanism for script in Lua to lookup and interface with objects in C#. Applicants have significantly improved the performance of NLua by modifying the caching and lookup systems used for mapping Lua to C#, which allows the Applicants to execute scripts that interact with native C# object at higher rates than were previously possible.

This approach may be advantageous and used to achieve the performance required when using scripts with higher frequency simulations, communications, and native UI controls.

To improve the performance of certain mathematical operations in Lua, Applicants added support for matrix and vector types as well as matrix and vector operations. To accomplish this, Applicants leverage a Math.Net Numerics library by creating interface classes that wrap various matrix and vector types (including dense, sparse, diagonal, identity, etc.) as well as operators and exposed these to NLua so that these types and operators can be used directly in script. For example, such an approach may provide advantageous uses such as in simulating custom or dynamically-defined systems and in computations for graphics that can be used in conjunction with the plotting framework and tools.

### 2.1A Automatic Theme Updates

In order to allow users (104, 105) to apply consistent styling and features to their documents, the concept of document themes may be supported by the platform.

Themes may be applied by creating a separate XML file (theme file) that defines various styles, scripts, and content to be used across multiple documents and then including the theme file (by a reference to the theme file) in each document and publishing the bundle containing the document XML file as well as the theme file.

Another mechanism for using themes in a document includes referencing a theme file that may be available on the server. The theme file may be stored as a user-specific theme file accessible only to the owner (author), or a core theme (built into the platform) that may be available to all authors. The theme file may also be hosted externally by a third party and referenced by a URL in the document so that the server can download and apply the theme file.

Server-side theming may provide several advantages. Firstly, authors do not need to manually copy the theme files (XML files and resources such as images, videos, data files) directly on their local authoring machine since they will be included into the final bundle when the server is processing the document for publication. Also, by managing themes on the server, the server can detect when a user created or predefined theme has changed and push updates to all documents that have been published using that theme.

The server can be configured to detect which documents have used a particular theme and automatically notify each author to request authorization to republish their existing documents so that they include the updated theme. Authors may also pre-authorize the automatic republishing of documents when a theme changes (either a theme they have created or a third party theme updated by someone else). This provides a mechanism for authors to update their documents by changing a common theme, and can be leveraged by institutions, such as universities or corporations, to not only provide a consistent theme for authors belonging to the institution, but also to change aspects such as the layout, styling, and even standard content (footers, copyright statements, etc.) across multiple documents at once.

### 2.1B Publishing Application/Document Workflow

A sample workflow for single click publishing, automatically bundling document with resources, processes document references to eliminate unused resources (e.g., images) may be provided, according to some embodiments. There may be various steps described, including the application of various themes.

For example, the authoring tool may be configured to provide a publishing application workflow which is comprised of some or all of the following steps:

Author develops a XML-based document/cross-platform knowledge application along with integrated Lua scripts.

When the author is ready to preview the document/cross-platform knowledge application on a physical device (e.g. iOS/Android phone/tablet), authors use the single click publish button which performs the following steps described in further detail below:
Packaging & Submission
Pre-processing of Bundle
Validation of Bundle
Processing of Bundle
Post-processing of Bundle

Back-end services may be geographically positioned to reduce the overall latency between the authoring tool and services through the use of cloud-based systems (i.e. Microsoft Azure, Amazon S3). While various details of the publishing workflow are provided below in greater detail, the following aspect of the framework may be emphasized:
A user (104) authors a document/knowledge application using a cross-platform XML-based language.
After using the single-click publish button in the authoring tool, the document/knowledge app goes through the publishing workflow as described below (e.g., in seconds).
When the final processed document is loaded on an iOS or Android mobile device seconds later, the cross-platform XML-based source code is used to dynamically generate native UI components and wire up the scripting logic dynamically on the executing platform.

The speed of going from cross-platform XML code into a natively executing application through the framework is a potentially innovative aspects of the platform, as traditional approaches to application development require knowledge of platform-specific APIs, platform-specific programming languages and going through application review process, etc.

Some embodiments of the present framework may reduce the development time of native application logic from an order of months into seconds.

### 2.1B.i Packaging & Submission

The system may be configured to perform the steps of:
Packaging the folder with the document and resources (e.g. images, videos, plot/simulation data, etc.) into an archive file;
Establishing a secure connection with the back-end repository service and uploading the archive for validation and processing;
Receiving the archive on the backend; and queuing it for validation and then processing.

Validation and processing may be a distributed and dynamic process whereby a central server receives and queues the bundle from the authoring tool, one or more server nodes capable of validating and processing the bundle report provides their current status (e.g. available, unavailable) to the central server, a dispatcher (software algorithm) determines which node to dispatch the queued job of validating and processing.

A distributed and dynamic process in accordance with some embodiments may be a silent process (e.g., invisible) to the end-user (e.g., the authoring tool communicates only with a singular endpoint and the various supporting server nodes are hidden from the client), and scalable (e.g., the backend server nodes can be scaled dynamically depending on the current load being experienced by the servers. If the nodes are being overworked, new nodes can be spun up and deployed to reduce the overall validation and processing time).

### 2.1B.ii Pre-Processing of Bundle

After submission, steps involved for the pre-processing of the bundle may include but is not limited to:
In-lining remote document fragments (i.e. fragments of XML code which are referenced by a URL) on the server-side (e.g., remote fragments are retrieved by the server-side and a local copy is stored prior to validation).

Server-side theme integration (i.e. themes which contain stylistic XML code which are referenced) which may be described in a previous section.

### 2.1B.iii Validation of Bundle

After pre-processing the bundle, validation may include, but is not limited to:
If a document/knowledge application fails validation (e.g., due to syntax errors, missing resources, etc.), the server responds with a descriptive error.
In the case of syntax errors, the exact line and column number is provided for the author to debug the document/knowledge application with ease.

Validation may occur rapidly (e.g., almost immediately and/or within seconds of the author using the single click publishing) on one of the distributed and dynamic server nodes.

Validation steps include but are not limited to:

Running the XML document against an up-to-date version of the schema defined by the framework language (to ensure proper form);

Validating syntax of mathematical equations (i.e., LaTeX strings) for correctness. Checking that all referenced local resources (i.e. embedded images, videos, data files) do exist and can be opened; and

Checking that all referenced remote resources (i.e., online images, videos, data files referenced by their URLs) do exist and can be retrieved.

### 2.1B.iv Processing of Bundle

After validation, processing includes but is not limited to:
Stripping unused resources (e.g., resources which are not used by the document and any in-lined fragments/themes are removed from the bundle to reduce the overall payload size of the final package);
Resource optimizations (e.g., included and referenced resources, including but not limited to images may be optimized for consumption on mobile platforms by, for example, changing file formats to reduce the overall payload size, re-encoding (e.g., transcoding) files for better consumption on mobile devices and to reduce the overall payload; resizing images for reduced memory usage on mobile devices when the document is rendered.
Math (LaTeX) generation (e.g., each in-line and block equation is queued for server-side math generation (see previous section for additional details).
Metadata archival (e.g., the metadata included in the start of the XML document is processed and stored in databases to enable faster queries from the mobile application when a user (104, 105) is searching for a specific document).

### 2.1B.v Post-Processing of Bundle:

After processing, post-processing includes but is not limited:
Generating a compressed archive with the final contents of the bundle after the processing step.
Cryptographically signing the archive with the author's signature so that it can be validated and trusted for consumption on the mobile application.
Storage and distribution of the bundle across multiple geographical locations through the use of content delivery networks (CDNs).
Integration of push notification services to inform any users (104, 105) who have a current version of the document that a document is available for download.
“Live Reload”, where, for example if the author has a mobile device with the document which is currently being updated and the metadata flag is set to indicate that the document is currently being authored, the author may use a “live reload” functionality.

The live reload functionality may include, when the mobile application loads the document which is being authored, the mobile application opens a lightweight socket-based connection to a remote endpoint (e.g. via technologies like SignalR or Websockets).

One of the post-processing steps is for the server to notify any connected “clients” (if any) that an update has occurred. In the event of an update, the server sends a lightweight flag to indicate to the mobile application that an update is available. If an update is available, the mobile application updates its local copy with the contents retrieved from the server again.

The result is a system whereby an author can publish changes to a document using an authoring tool and the document/knowledge application is “live reloaded” within seconds on the mobile device (without any interaction). The workflow may provide a “single click publishing” aspect of the framework where it takes a single click from providing the XML code to publish a natively executing document or application on hardware.

### 2.1C Intelligent Authoring Tool

The platform may include various analytics used to suggest/use different features and content based on user history, author account, author group (e.g., institutional themes, snippets).

Framework applications may be configured to track various key analytics metrics (e.g. usage and interaction with various components, etc.) for the purposes of training a machine intelligence authoring system which is capable of adjusting and suggesting content provided by authors.

Various metrics may be collected, including but not limited to:

Student/user (104, 105) interaction with various components used in a document/knowledge application.

Student/user (104, 105) success of answering questions depending on consumption of content across different learning modes (i.e. auditory, visual, hands-on learning etc.).

The analytical data can be used to develop profiles for user engagement across various dimensions including but not limited to: geographical, institutional (e.g., students at a university), user age, document/app category or topic.

Such profiles can then be used to provide intelligent authoring systems capable of suggesting and/or creating templates for content that is applicable to the author, their institution, or the target readership/user base. For example, using the intelligent authoring system, an institution can provide profiles for content that describe the desired features of content, learning modes, relative content type usage (percentage of text, video, audio, Q&A, interactive simulations, exercises, etc.), content patterns, and more.

These content profiles may be used by the intelligent authoring system to provide content structure and recommendations for authors belonging to that institution such that they can more easily produce content that matches the specifications of the institution's profile.

Another use of the intelligent authoring tool can be to utilize content profiles that recommend different types, patterns, and structures of content for an author such that the author can provide multiple implementations or modes of their content. These multiple modes can be used to intelligently select one or more content modes when a content consumer is consuming the content (see Intelligent consumption tool). An author can provide the same content using different modes to allow the system to provide an improved content consumption experience.

### 2.1D Intelligent Consumption Tool

The application can be configured to restructure the semantic definition of content provided by authors to adapt to the user's (104, 105) profile (based on learning mode inference, past interaction, score on Q&A type content, etc.).

The application may be configured to collect elements of analytics data on usage and feed this data back to the intelligent authoring tool to improve the quality of the overall content.

The content profiles built using analytical data may be used to dynamically modify the content views being presented to the user (104, 105). If an author provides different versions of the same content to teach a concept, the intelligent consumption tool may be configured to automatically select the version of the content best suited to convey the information based on the user's profile.

The user (104, 105) would also have access to view the other versions of the content and provide feedback to further improve the user profile. The intelligent consumption tool may also use context sensitive information to dynamically alter the version of the content being presented. For example, if an auditory version of the content is available and the user (104, 105) plugs in headphones, the auditory version may be presented alongside the visual content and automatically do the change of context.

The contextual awareness may extend to other cues such as geographic location, device sensor readings, etc. Further analytics metrics may be collected by the intelligent consumption tool to provide feedback to the author so that they are aware of which versions of the content was consumed most to further improve the semantic version of the content. The intelligent consumption tool may also enable “social learning” scenarios where a user (104, 105) can provide feedback on a particular piece of content which is shared through social network APIs.

For example, a user (104, 105) may “like”, “thumbs up” or “vote up” a particular version of a piece of content which the intelligent consumption tool would present to others members in the user's social network. The intelligent consumption tool would also give greater priority to this version of the content when presenting it to others users (104, 105). This provides a community driven mechanism for good content to be surfaced and displayed to other users (104, 105).

### 2.2 Dynamic Interface Definition

In some embodiments, the system may be configured to interact with one or more objects under test (300). Various functionality may be provided to enable interaction with the one or more objects under test (300) in an automated or semi-automated manner. For example, to interoperate with an object under test (300), instructions and/or information may have to be communicated to and/or from the system. The rapid, automated and/or streamlined definition of interfaces supporting the communication from the system to the one or more objects under test (300) may be useful to provide convenient and easy-to-use functionality requiring minimal user input and/or manual configuration. As such, the requirement that a user (105) and/or author (105) invest time and resources into establishing interoperability with one or more objects under test (300) may be reduced.

In some embodiments, the various objects under test (300) that are available for interaction may fall under one or more categories wherein the system may have libraries of pre-defined functions and interfaces. Where a new object under test (300) is introduced for interoperability with the system, if the object under test (300) falls within one of these categories, the system may be able to automatically generate a base set of interfaces for interoperability. For example, a pre-defined set of interfaces and/or functionality may exist for inverse pendulums having a particular specification, and a new object under test (300) may be detected as such and a selection of those pre-defined interfaces may be utilized.

However, where a new object under test (300) may not clearly fall into a category, or has functionality beyond those provided in a category, the system may be configured such that the system approximates and selects/extends existing interfaces to adapt to the new object under test (300). For example, the system may detect that a new object under test (300) appears to have functionality similar to known categories of objects under test (300), and may automatically define a new interface having functionality automatically selected from known interfaces in order to support the functionality present in the object under test (300).

In some embodiments, the object under test (300) may have one or more interface files located on memory on the object under test (300), or readily available from a third party system. In these embodiments, the system may be configured to retrieve the interface files and generate an interface, either from the interface files located on the object under test (300) or from various third party systems.

The functionality described above regarding the definition of interfaces for interoperability with objects under test (300) may be helpful where the system is being utilized with an object under test (300) wherein a pre-defined interface does not already exist, reducing the need for manual interface definition and/or skill in an author/user (104, 105) to define such interfaces manually.

An object under test (300) may include various objects, and may include virtual and real objects. For example, an object under test (300) may include an electronic circuit, a truss element, an inverted pendulum, etc. The object under test (300) may further include various functionality, such as one or more sensors, and/or the ability to operate various motors, etc. Interacting with the one or more objects under test (300) may require the communication of information, such as command instructions and/or sensory data.

These objects under test (300) may have various interfaces associated with them, so that various signals may be transmitted to and/or received from the objects. These interfaces, in some embodiments, may provide a set of commands that may be issued to the objects under test (300) to interact with the objects, such as commands that control the movement of the objects, request the transmission of sensory information, etc.

In some embodiments, the system may be advantageously configured so that the system may be able to interface with objects under test (300) without having a pre-existing interface loaded on to the system. The interfaces may be provided on a dynamic basis from various sources, such as a third party database, or the architecture/schema/functions/variables/logic/memory associated with the object under test (300). A potential advantage of such a configuration is the increased ease of interoperability with various objects under test (300).

In some embodiments, the system may be configured to connect to an object under test (300) in an ad hoc manner and/or stream the object under test (300)'s interface document to the mobile application, generating an interface to provide the ability to interact with the object under test (300).

The content player system (200) may be further adapted to dynamically download and create interfaces (pages and content) from a remote source (such as an object under test (300)) and embed them in content, such as a document, for presentation and control.

This feature may potentially be useful for content that are used to connect to remote clients (such as hardware experiments connected to a PC or other mobile devices) and whose interfaces are not yet defined at the time the document is written.

As an illustrative example, a professor wishes to include in content teaching how a particular non-ideal electronic circuit behaves in real life. The functionality would allow this professor to develop content indicating that there will be controls related to the non-ideal electronic circuit, prior to the interfaces being created to control the non-ideal electronic circuit. In this example, the system could dynamically download and create interfaces when a student is using the content, rather than setting out the interfaces when the content is generated by the professor.

This feature may also allow remote clients to define their own interfaces, which may then be used to dynamically create the content within the application document as well as define the communication structures used to send and receive data between the document and the remote client.

The interface may be comprised of controls and indicators as well as static content such as text labels and images. Controls may be content types with which the user (104, 105) interacts and these are intended to provide input data to the remote client. Indicators may be content types that are used to provide the user (104, 105) with information sent from the client such as plots and other display fields. These elements may be used to define the communication packets between the application and the remote client, among other elements.

The content player system (200) may be configured for wired/wireless communications as well as dynamic content interpretation and layout. Using these features, the application can connect to a remote client system and receive data from this client containing information for the contents of an interface used to control and monitor that client.

FIG. 4 provides a block diagram where an interface is being dynamically defined, according to some embodiments. The dashed lines represent wireless connections using the application's communication subsystem (232).

In FIG. 4, The process may be carried out as follows:
1. The application loads the document (402) from its library (234) to generate the interpreted document that is displayed to the user (104, 102).
2. In a portion of the source document (402) (e.g., a page or part of a page), the author (105) may specify that content is to be remotely downloaded and inserted in the page.
3. The Uniform Resource Identifier (URI) that defines a connection to the remote object under test (300) may be specified in several ways:
   a. the author (105) explicitly specifies the connection details for connecting to the client (using a fixed URI), or
   b. controls are presented to the user (104, 105) to specify the URI, or
   c. connection details are captured using the device's on-board camera via a QR code or equivalent scannable URI encoding or via NFC, wifi, Bluetooth, etc.
4. When the page is being prepared for layout, the application attempts to connect to the remote client using the communications subsystem (232).
5. When the connection to the remote client is established, the client transmits to the application a serialized document (404) that specifies the definition of content for the client's interface using the same content definition language used for standard documents.
6. The application deserializes the interface definition document and proceeds to parse the deserialized document using and construct the content for the interface using (218), adding the content elements directly in the page. The application uses the same facilities it uses for normal document parsing and interpreting.
7. The interface content provides the necessary controls (user input) and indicators (remote client outputs) that the user (104, 105) then uses to control the remote client and monitor its behavior. The controls and indicators form the data packets that are transmitted between the application and the remote client.
8. The wireless connection to the client is established and data is transmitted between the application interface and the client using the communications subsystem (232).

In some embodiments, the full document can be transmitted directly from a remote object under test (300) instead of just a page or a portion of a page. In these situations, the object under test (300) can be broadcasting a wireless signal, for example, indicating to the application/content player (200) which is nearby (e.g. over Bluetooth LE or NFC technology).

When the application/content player (200) “discovers” dynamic content from a remote object under test (300) broadcast, it can use the communications subsystem (232) to establish a connection to dynamically generate the interface using steps 5-8 above.

### 2.3 Globally Unique Identifiers (GUIDs) for Content

In some embodiments, the system may be configured to utilize globally unique identifiers (GUIDs) for element referencing and smart document versioning: using content GUIDs for referencing elements within a document as well as for allowing authors (104) to perform one or more document revisions while keeping the consumer's state information (settings, notes, input values, etc) intact across document revisions.

These GUIDs may be provided in various formats, and may additionally be utilized as/in conjunction with primary keys, foreign keys, relationship models, hash indices, etc.

Various elements of the system may utilize the GUIDs when operating with data and/or information related to one or more documents.

### 2.4 Algebraic Loop Handling

In general, models used in simulating dynamics may be directed cyclic graphs.

As the graphs may allow cycles, it is possible that the system engages in the analysis of algebraic loops. The convergence of algebraic loops may determine whether an algebraic loop can be solved. If an algebraic loop cannot be solved, the system may have to break the loop as otherwise the system may be stuck in the loop.

Further, it may not always be possible to avoid an algebraic loop.

The system may be configured to handle algebraic loops; the simulation subsystem (224) may be configured to automatically detect algebraic loops and to optionally allow the loop to attempt to be solved iteratively (until it converges or fails to converge) or to split the loop by detecting a loop breaking point that maximizes the number of loops that are broken, thus minimizing the number of unit delays in the system that may be required to break the loop without having the user (104, 105) manually insert these unit delays in their models.

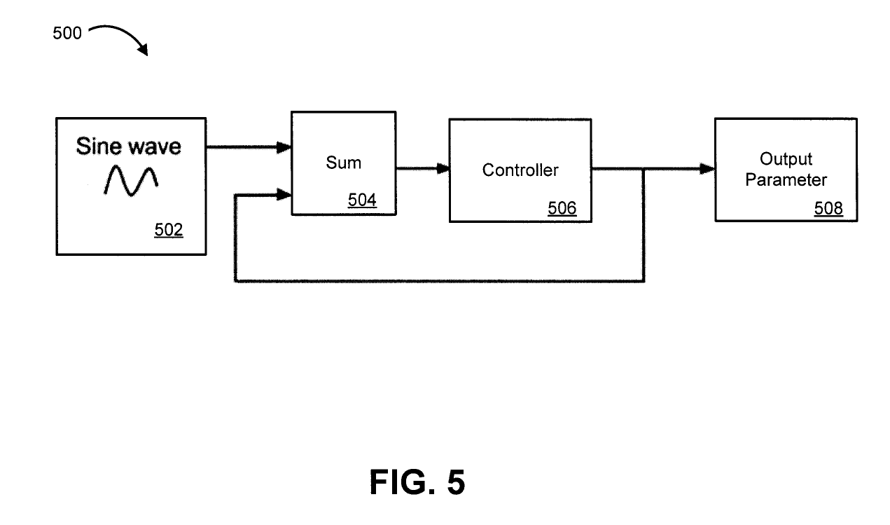

FIG. 5 shows such a loop/cycle that may flows from, for example a sum function, to the controller system, and back to the sum function, according to some embodiments.

In some simulations, the algebraic loops end up converging, which allows the algebraic loop to be solved. In other simulations, the algebraic loops do not converge and the algebraic loop will have to eventually be broken. It is often difficult to be certain whether an algebraic loop converges or diverges over time.

In order for the simulation engine (224) to resolve and compute the states of each signal during each simulation time step, the simulation engine (224) may be configured to either insert a unit delay in one of the signals in the loop (edges in the graph cycle) or to attempt to iteratively calculate the signal values in the loop until these values converge.

The simulation engine (224) may be configured to attempt to iteratively solve the algebraic loops, if this is specified by the author user (104).

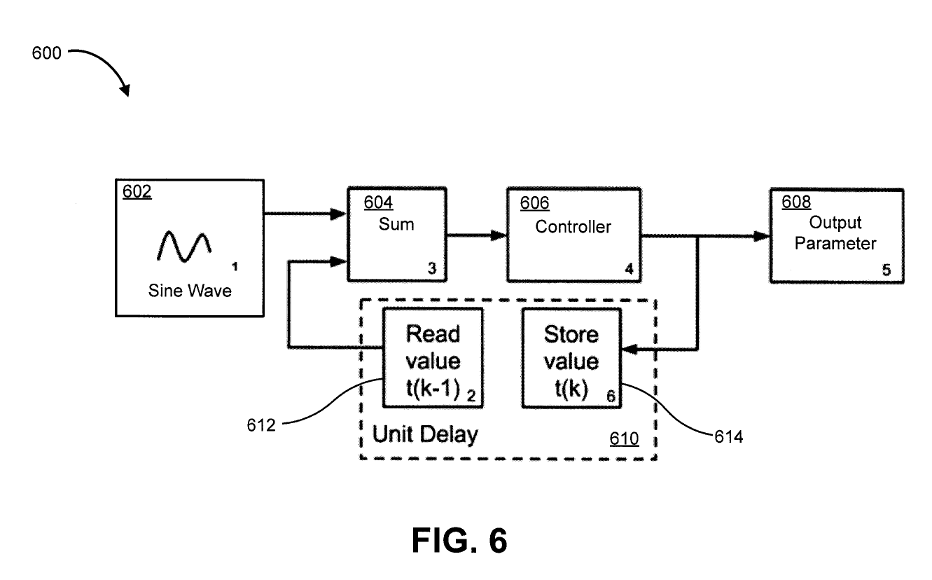

In general, however, it cannot be certain that algebraic loops will converge, so a common solution is to eliminate the algebraic loop by breaking the loop. Inserting a unit delay in a signal within the loop will effectively break the loop, as shown in FIG. 6.

In FIG. 6, the algebraic loop has been broken by inserting a signal delay that samples and holds the signal value. In this example, the store value portion stores the value of the signal during the current time step; the read value portion supplies the value that was stored in the previous time step (hence the unit delay). The simulation subsystem (224) may be configured to determine an acyclic execution order of the model systems that it can evaluate at each time step; the numbers in the block diagram corners of the blocks in FIG. 6 indicates one possible execution order.

In such an embodiment, the author (104) would not have to manually insert additional systems in their model simply to avoid algebraic loops, which may potentially improve usability. The user (105) may still be able to manually insert these unit delays if the user (105) wishes.

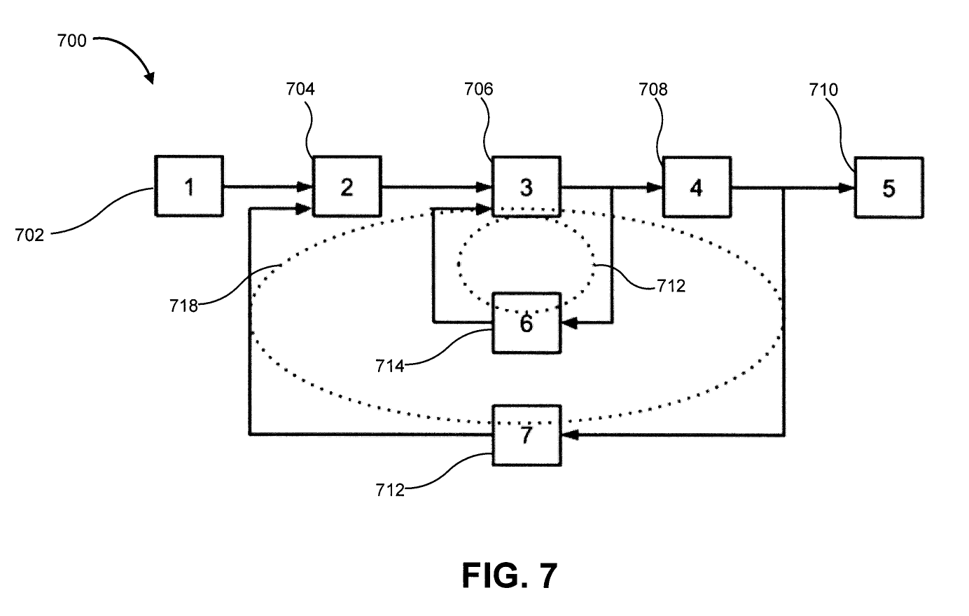

Another feature that may be provided by the system with respect to the algebraic loop handling algorithm is the determination of the optimal point for breaking the loop in order to minimize the number of delays inserted. FIG. 7 shows a model with multiple algebraic loops (716, 718), according to some embodiments.

FIG. 7 provides an example model with two algebraic loops (716, 718) shown with dotted ovals. In this instance, both loops could be broken separately so that no algebraic loops remain (e.g., by placing unit delays immediately before or after systems 6 and 7). However, inserting signal delays in the model may generally be undesirable unless it is unavoidable. In the above example, as is common in many system architectures, such as cascade control structures, both loops share a signal that is the output of system 3.

The algorithm processes the graph of the model and identifies possible points where unit delays can be inserted in order to minimize the number of unit delays used to break all algebraic loops in the model.

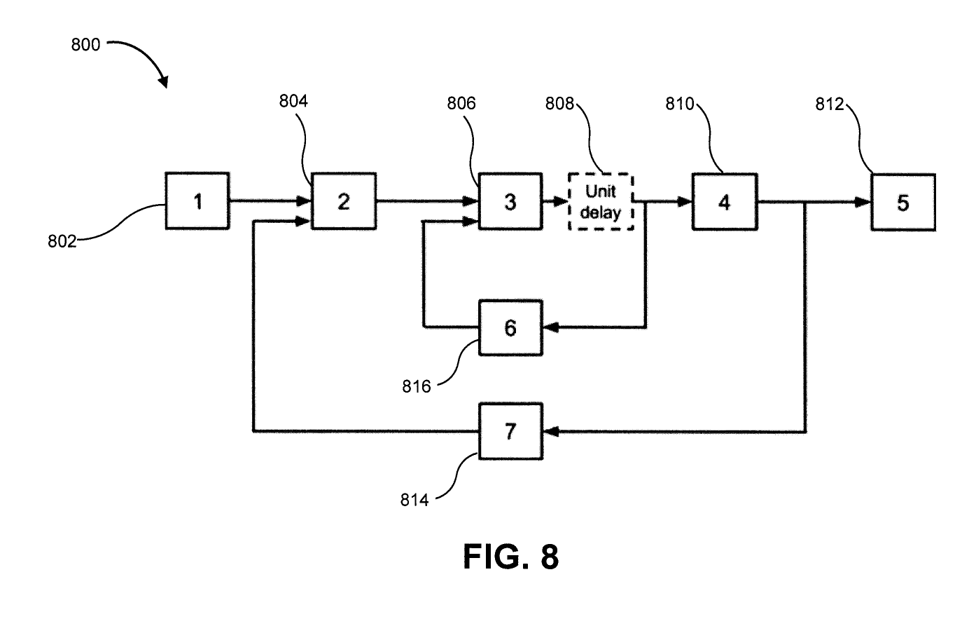

As shown in FIG. 8, the algorithm could place a single unit delay (808) after system 3.

The single unit delay (808) may effectively break both algebraic loops (716, 718) without the need to add more delays to the model. The algorithm performs the necessary processing of the model graph before running the simulation to ensure there are no algebraic loops (716, 718) and if there are, that they are broken by inserting a minimum number of delays (808) into the model.

### 2.5 Multi-Rate Simulations

The importance of timing may depend on the context. In purely simulated models the timing may not be as important. However, in systems where there is a mixed simulation/real signal model (e.g. simulating alongside an actual experiment), then depending on the interconnectivity of these systems, the results may be skewed due to time lag or a time lag may even destabilize the actual hardware experiment. Timing accuracy may be a major concern when running closed-loop systems.

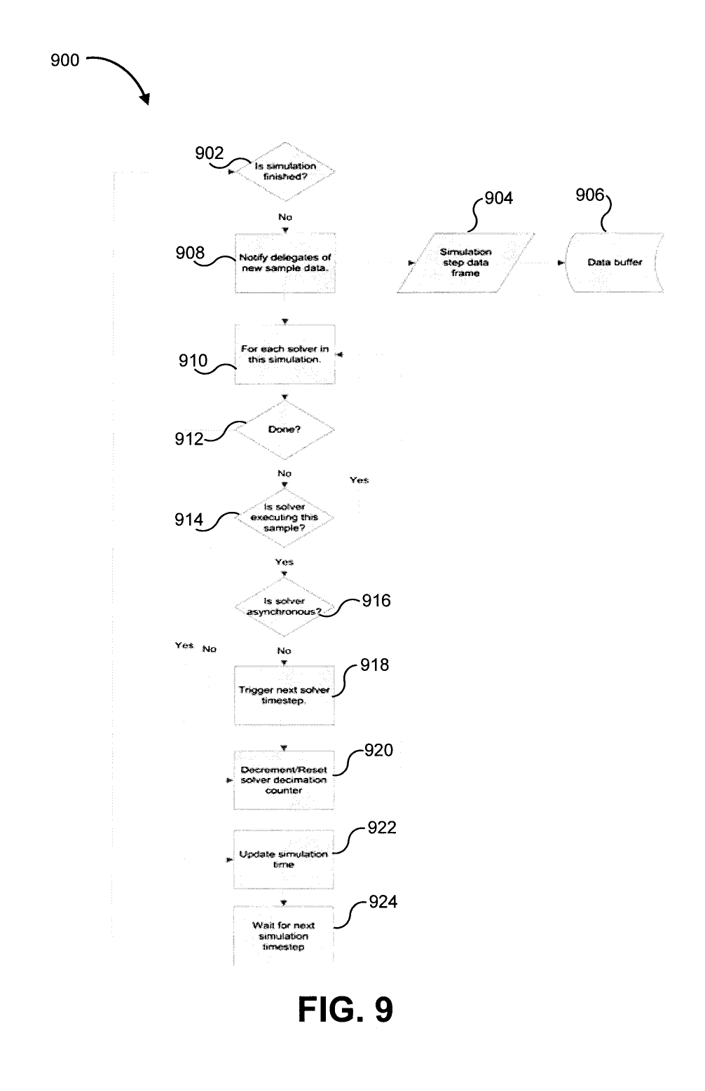

FIG. 9 provides a sample flow chart for timing and execution, according to some embodiments.

The simulation subsystem (224) may be configured for models to be connected to each other regardless of their intended sample rate (in some embodiments, even providing connections between synchronous systems and asynchronous systems).

When a model is assigned to a solver, the solver determines the rate at which the models is executed.

The simulation engine (224), during initialization, may be configured to traverse the graph structure of the model (directed, cyclic graph of connected systems) and automatically handle connections between systems running at different rates by inserting rate-transition parameters to synchronize signal flow across these systems in a deterministic manner.

As with the algebraic loop handling, these transitions do not need to be handled by the author since the simulation subsystem (224) may be configured to automatically resolve the transitions. These rate transitions also allow connections between synchronously-triggered and asynchronously-triggered systems.

### 2.6 Multi-Peer Data Streaming

The system may be configured for providing multi-peer data streaming functionality. Multi-peer data streaming functionality provides the ability for one or more devices to stream data to another group of one or more devices.

In some embodiments, the system (10) may also be configured for providing multi-peer data streaming to and from one or more devices (e.g. app-to-app communications).

As an example, where the system (10) is utilized in a classrooms/labs setting, the system (10) may be configured to enable a presenter (104) (such as a professor or an instructor) to stream data from their device (e.g., simulation data, measured data from an object under test (300)) and broadcast this data to a group of consumers (105) (e.g., students). A member of the group of consumers (105) can then display the incoming data and also combine it with local simulations or other data specific to that consumer (105), allowing them to interactively study a model locally alongside one provided from an instructor.

As an example, multi-peer data streaming may be used when an instructor wishes to run a simulation on their device and stream the simulation output to a group of students. In some embodiments, the instructor can either post the URI for the students to enter manually or use the content player to display a scannable QR code (1014) containing the URI information (e.g., the URI ‘udp://192.168.1.103:10?broadcast=yes’ can setup a broadcast stream between the instructor and many students using the User Datagram Protocol (UDP)). In FIG. 10, a sample QR code (1014) is provided for illustration, according to some embodiments. Once students have established a connection to the stream, the instructor's simulation data may appear in real time on the student's plots, which they can then save, analyze, and/or export, among other activities.

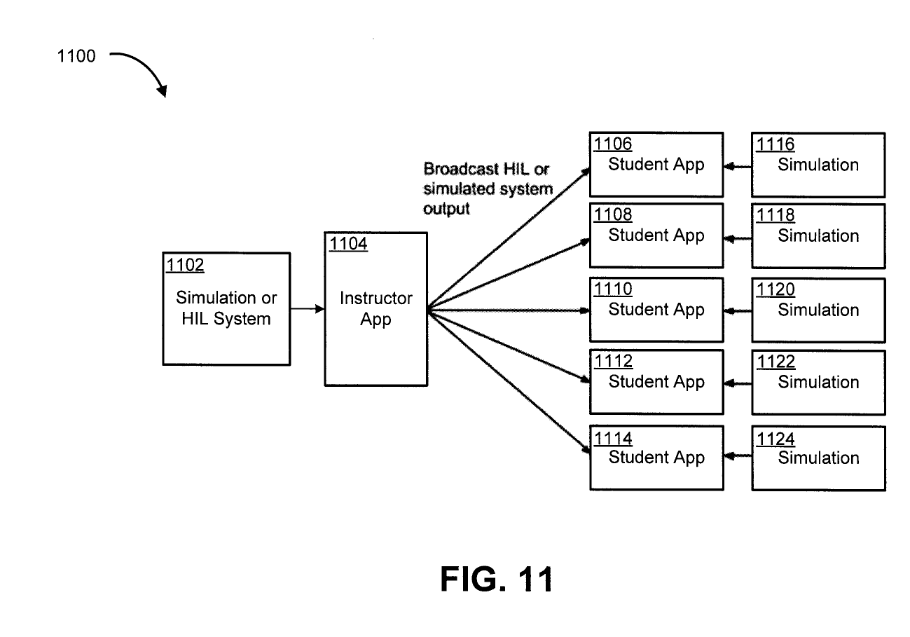

The functionality may be combined with simulations and hardware in the loop systems, for example, where an instructor is streaming his or her results (from a simulated system or a real hardware in the loop system) to several students. FIG. 11 provides a simple block diagram illustrating the connections between a teacher's device (1104) and a number of student devices(1106-1114), according to some embodiments.

The students may be simultaneously running a simulation (1116-1124) of the system and their goal is to tune the parameters of their simulated system and/or controller so that their simulated system output matches that of the instructor. Each student can locally simulate the system being studied and simultaneously plot the stream of the instructor's system and their simulated system (1116-1124), thus allowing them to compare the two. This exercise can be applied to tuning model parameters for system identification as well as for tuning controller parameters for matching the closed-loop response of the instructor's system.

The communications subsystem (232) may be the central subsystem which handles communicating with other instances of content player systems (200).

The communications subsystem (232) may be configured to provide an abstraction layer on top of native hardware and enables communication over a wide variety of network protocols, e.g., TCPIP, UDP, serial, file, Bluetooth, NFC, etc.

In the case of multi-peer streaming, one or more subsystems in the application/content player (200) work together with the communications subsystem (232):

In an example, where there are two or more instances of the application/content player (200) being used by students in a lab environment where each student is responsible for completing a different section of the document, the changes made by each student in their local instance of the application/content player (200) may be streamed to the other students' instances of the application/content player (200).

In contrast to real-time document linking as may be indicated in Section 2.8 of this specification, the changes made across multiple instances of the application/content player (200) can be synced simultaneously.

Multi-peer streaming may provide a many-to-many streaming configuration while the real-time document syncing provides a one-to-many configuration.

### 2.7 Collaboration, Social Networking, and Learning Management System Integration

The content player system (200) may be configured to provide functionality for collaborative working, social networking, and/or integration with learning management systems.

Peer-to-peer streaming capabilities may be provided in some embodiments in which multiple users (105) (consumers) are operating the application and interacting with each other in a collaborative fashion (e.g., each team member is monitoring measurements from an experiment and each team member is able to interact with the experiment).

The social networking aspects may be functionality provided by the application programmable interface (API)/Service Consumer (244) subsystem.

An author can build in social aspects to the content developed for the system by integrating with one or more third party social networks through a API/Service Consumer (244) subsystem or through deep linking with other apps on the device.

A publicly available social network API (e.g., Facebook™, Twitter™) can be integrated and consumed by one or more subsystems in the application/content player (200).

The author can define content which is publishable to a social network using this subsystem after the user (104, 105) has interacted with the content.

For example, the system (10) may be configured to allow a user (104, 105) to execute a simulation using the simulation and solver tools subsystem (224) and to publish the resulting plot generated by plotting/2D line drawing (210) subsystem to their private social networking profile (e.g. Facebook) via the API/consumer subsystem (244).

The content player system (200) can also contain features for communication among other users (104, 105) including social networking, forums, and chat/messaging services.

In some embodiments, these features may be used to monitor and respond to questions/comments from a group of students in a classroom by the instructor, teaching assistants, or other moderators.

The content player system (200) may also contain features for communication with learning management systems which may be used for but not limited to delivery of learning materials to students, reporting, testing, assessment, and grading.

### 2.8 Near Real-Time or Real-Time Document Linking

In some embodiments, the system (10) may be configured so that two or more devices with the same document can be linked so that one user (104, 105) acts as the presenter and changes that one or more users (104, 105) makes to the document are pushed to the receivers in real time so state changes appear to all the receivers (e.g., prof navigating through a document, changing values in a simulation, highlighting text, etc). The linkages may be configured in various topologies, such as in a one to many topology, etc.

In some embodiments, the system (10) may be configured to provide the above linkage capabilities even though the devices and/or associated software may be heterogeneous in type. For example, if the presenter is using a particular type of device and the recipients are using other types of devices, which may not be the same between presenter and recipient or even between recipients, the system (10) may be configured such that the content is displayed/rendered/formatted properly independent of the presenter's device type. The system (10) may accomplish this by, for example, providing abstracted content from the presenter's device to be rendered independently by each of the recipient devices. A potential advantage of such embodiments is a lack of a need for all the presenters and recipients to utilize similar devices.

The communications subsystem (232) may be configured to handle communications with other instances of application/content players (200) and/or other devices (e.g. PC's, embedded systems, etc).

This subsystem may provide an abstraction layer on top of native hardware and may enable communication over a wide variety of network protocols.

In the case of real-time document linking, one or more subsystems in the application/content player (200) work together with the communications subsystem (232).

As an illustrative, non-limiting example, there may be two or more instances of the application/content player (200), including the host instance of the application/content player (i.e. being used by a professor in a classroom) and one or more client instances of the application/content player (200) (i.e. being used by one or more students in a classroom).

Any subsystem in application/content player (200) including, but not limited to, the expression evaluator (242), plotting/2D line drawing (210), plot analysis tools (214), etc, undergoing a change in state (i.e. a parameter updated from a slider triggering an expression to re-evaluate with its result displayed on a plot) communicates the change to the communications subsystem (232) in order to be streamed to any connected client instances.

The client instances of the application/content player (200) may be configured to be listening for new state changes through the communications subsystem (232). Once a state change is received from the host instance, the equivalent subsystems in the client instance update their state to mirror the change.

The result of this implementation of subsystems working together is that an author can navigate a document loaded in the application/content player (200) and any connected student(s) can observe the changes on their own local device/instance of the application/content player (conceptually similar to observing through a remote desktop).

A potential distinction between a remote desktop implementation and the document linking feature is that remote desktop transmits video of the presenter's screen where the document linking feature transmits only the state change information from the presenter's document, which may require less data transfer than remote desktop video. In a one-to-many situation (e.g., a professor sending to a classroom of many students), the advantages of minimizing the amount of data transmitted to the “viewers” may be important.

### 2.9 2D/3D Interface and Gesture Definition

In some embodiments, the system (10) may be configured to enable the authoring of 2D/3D graphics and the authoring of custom gesture interfaces.

In some embodiments, the author (104) can specify a custom interactive interface by specifying what actions are performed with a set of gestures. The author (105) can use the framework components (e.g., expression evaluation system, simulation system) to map gestures to perform some custom calculation or mathematical expression (242), which may be connected to a graphical 2D/3D visualization. The mapping of gestures to calculations may enable an author (104) to specify gesture-based interactivity with custom graphical representations.

In some embodiments, the gestures/sensors/device subsystem (208) may be connected with one or more plotting/2D line drawing (210) and/or 2D/3D graphics and animations (212) subsystems. An author (104) may be able to develop demonstrations of complex systems (through plotting and animation) which may be manipulated by the user (105) through intuitive gestures, allowing the author (104) to teach or demonstrate a concept.

For example, a high school physics teacher who is teaching the basics of optics (study of the behaviour and properties of light) can use the system to author a demonstration which represents a mathematical model of a concave mirror along with a 2D animation of a ray diagram.

When the user (105) interacts with this model using gestures (defined by the author/teacher), parameters of the mathematical model may be adjusted and the resulting changes may be displayed back to the user (105).

A potential benefit to the user (105) is the ability to help provide an experience of manipulating the physics/mathematical model through touch, which in turn may potentially help a student understand how a complex concept in physics/optics works by directly interacting with the model to adjust parameters with their gesture inputs.

In some embodiments, the system (10) may be configured so that the author (104) is able to use the authoring tool (100) to define the mathematical model (optics equations) using the expression evaluator (242) subsystem, and then mapping parameters in that expression to a custom gesture defined using gestures/sensors/device subsystem (208) via the Gesture API defined in this document. The resulting animations can be displayed through either the plotting/2D line drawing subsystem (210) or the 2D/3D graphics and animation subsystem (212). The author (104) may use the authoring tool (100) to define the characteristics of these various subsystems and connect everything together. When the content is deployed or “played” on the application/content player (200), these subsystems may work together to produce the desired end-user experience.

In some embodiments, the system (10) is further configured to enable bidirectional state changes between content and parameters. For example, an author (104) may define a page containing a slider, a numeric input field, and a gesture-enabled plot that changes the value of an underlying parameter, P, using a touch gesture. In this example, the underlying parameter value can be changed from (a) the user's (104) gesture mapped through the expression evaluation engine (242), (b) the slider position, and/or (c) the numeric input field.

By changing any of these three controls, the others may be updated to also reflect the new value. For example, initially, the underlying parameter P has a value of 3.14, the slider's position corresponds to a parameter value of 3.14, and the numeric input field contains the value 3.14 so that elements are synchronized.

If the user (105) performs the appropriate gesture, the value of the parameter P changes to 2.72, the slider's position automatically changes to represent the new value 2.72, and the numeric input field's value is 2.72; these changes all happen simultaneously and continuously throughout the manipulation of the underlying value.

If the value is changed by any one of the controls, the others may also be updated. Thus, each control may act not only as a data source but also as a receiver of data or display that can be updated. The synchronization between these control elements may be handled by the system (10) any time a control is semantically linked to another either directly or via a shared parameter.

### 2.10 Augmented Reality Overlays

In some embodiments, the system (10) may be configured to provide augmented reality visualizations where simulated and measured data may be overlaid on real-time images and video of objects under test (300). For example, a simulated pendulum can be shown on top of real-time video of a pendulum under test (300) that is also connected to the application using the stream API and the mobile device's camera.

To provide an augmented reality overlay, the system (10) may be configured to first identify the rates of the simulation and the object under test (300), and then match the rates such that an augmented reality overlay of simulated information may be readily understood by a human observer. In some embodiments, the specific location of the overlay may be automatically determined in a position on an interface wherein the user may be able to review information while not impeding the user's (104, 105) view of the depiction of the object under test (300).

In some embodiments, the overlay provides a user (104, 105) an ability to interact and/or modify one or more parameters associated with the object under test (300). The user (104, 105) may be able to review the simulated effects of the modification of the parameters, while comparing the effects of the modification of the parameters on the object under test (300). For example, a physical system may be compared against a simulation to consider the impact of variables not captured in the simulation (e.g. air resistance).

This functionality may potentially be useful in a learning environment, for example, where a user (104, 105) is seeking to determine where a particular simulation is no longer applicable to a physical system (e.g. boundary conditions, bounds for applicability of various modelling assumptions, the limits/effects of factors external to the simulation such as material strength).

As indicated above regarding 2D/3D animations, similar techniques may be used by the system (10) but also in combination with a live video feed that may be derived from any suitable source. For example, the on-board camera on a device may provide such a feed through the gestures/sensors/device subsystem (208).

### 2.11 Gesture Application Programming Interfaces (APIs)

In some embodiments, the system (10) may be configured to provide one or more custom single or multi-point touch gesture/sensor application programmable interfaces (APIs) for authoring intuitive interfaces. The system (10) may further be configured to indicate regions in the content where gestures could be used. For example, it could be indicated to a user (104, 105) that if the user (104, 105) makes a ‘Z’ gesture, the model characteristics may rotate, etc.

The one or more gesture APIs may be configured to use the gestures/sensors/device subsystem (208) to detect gestures at runtime on the application/content player (200).

An author (104) can use the authoring tool (100) to define custom gestures which can be associated to do any number of actions with one or more subsystems within the application/content player (200).

A few examples of custom gestures that can be defined:
A gesture can be defined so that drawing a “Z” on the screen of a device running the application/content player (200) may trigger the expression evaluator (242) which in turn re-determines the result of an expression tree whose result is displayed to the user (104, 105) using the plotting/2D line drawing tool (210).
A gesture can be defined so that shaking the device running the application/content player from left to right (not a touch based gesture) can introduce disturbance into a model being simulated using the simulation and solver tools subsystem (224).
The author can use the authoring tool (100) to specify a specific region on the screen where the gesture is active.

The gesture and region definitions may be cross platform and may be configured to operate in the same or similar ways regardless of device type, screen size, screen density, etc.

The gesture APIs may be programmable by the author and can work with one or more subsystems in the application/content player (200).

### 2.12 Hardware Abstraction Layer

In some embodiments, the system may be configured to provide a hardware GPU/DSP abstraction framework for image processing and filtering (209). The system may further provide on-board real or near real time image processing, and/or on-board real or near-real time audio filtering and signal processing (209).

The system may be configured to already provide the following tools to enable an author to define a mathematical system and have it evaluated at runtime in the application/content player (200):

Simulation and solver tools subsystem (224) for ODE-based systems

Expression evaluator subsystem (242) for any linear/non-linear set of equations

In addition to these two subsystems, the hardware abstraction layer may be configured to provide a cross-platform framework for the author to define algorithms to be executed on arbitrary hardware. The GPU/DSP abstraction framework (209) may translate this cross-platform definition of calculations and execute them using platform specific hardware acceleration.

### EXAMPLE APPLICATIONS

### 2.12.1 Audio Spectrum Analysis

Using the authoring tool subsystem (100), the author (104) can define content to capture an audio recording from the built in microphone via gesture/sensors/device subsystem

The author (104) can then define an algorithm which computes the Fast Fourier Transform (FFT) of the recording. This computation would then be executed with hardware acceleration at runtime on the GPU and DSP abstraction interface

The author (104) can then optionally choose to display the results of the computation (i.e. a frequency spectrum) using the plotting subsystem (210).

### 2.12.2 Image Processing Algorithms

Using the authoring tool (100), the author (104) can define content which uses the built in camera on a mobile device via the gesture/sensors/device subsystem (208). The author (104) can then define one or more image processing (e.g. edge detection, morphological operations, filtering) algorithms using the image processing tools subsystem (236).

Internally, these algorithms may then be executed with hardware acceleration at runtime on the GPU and DSP abstraction interface (209). The author (104) can use the combination of these subsystems to produce an example which displays a real or near real time video feed in the application/content player while providing buttons via the native UI abstraction subsystem (206) which may be configured to display the results of different image processing algorithms applied to the real or near real time video feed.

### 2.12.3 Generalized Parallel Computation

Using the authoring tool (100) the author can define an algorithm to perform a series of calculations in parallel. The algorithm would then be executed at runtime with hardware acceleration in the application/content player (200) by leveraging the native parallel processing power of the local GPU (209).

### 3.0 Other Figures

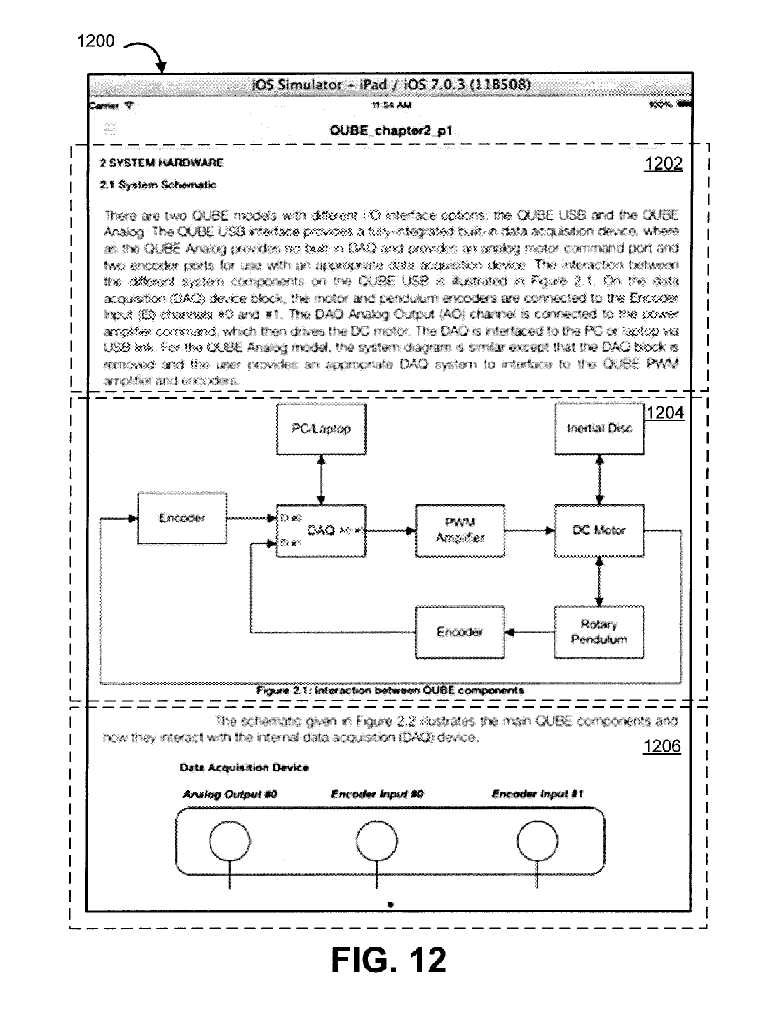

FIGS. 12-15 provide various screen captures according to some embodiments.

FIG. 12 illustrates a screen (1200) where the images are automatically sized to fit within the page width, according to some embodiments. The user (104, 105) may be able to specify the width of any content element as a percentage of the screen's/page's width or allow the default content sizing to be used (intrinsic content size). The layout manager may be configured to ensure that content (1202, 1204, 1206) items do not exceed the page's width. Here, the default image label formatting is seen on the Figure labels below their respective images.

Default content styling may allow the author (104) to produce content without needing to explicitly describe the content styling, and instead rely on the app to apply appropriate styling based on the type of content and context in which it is used.

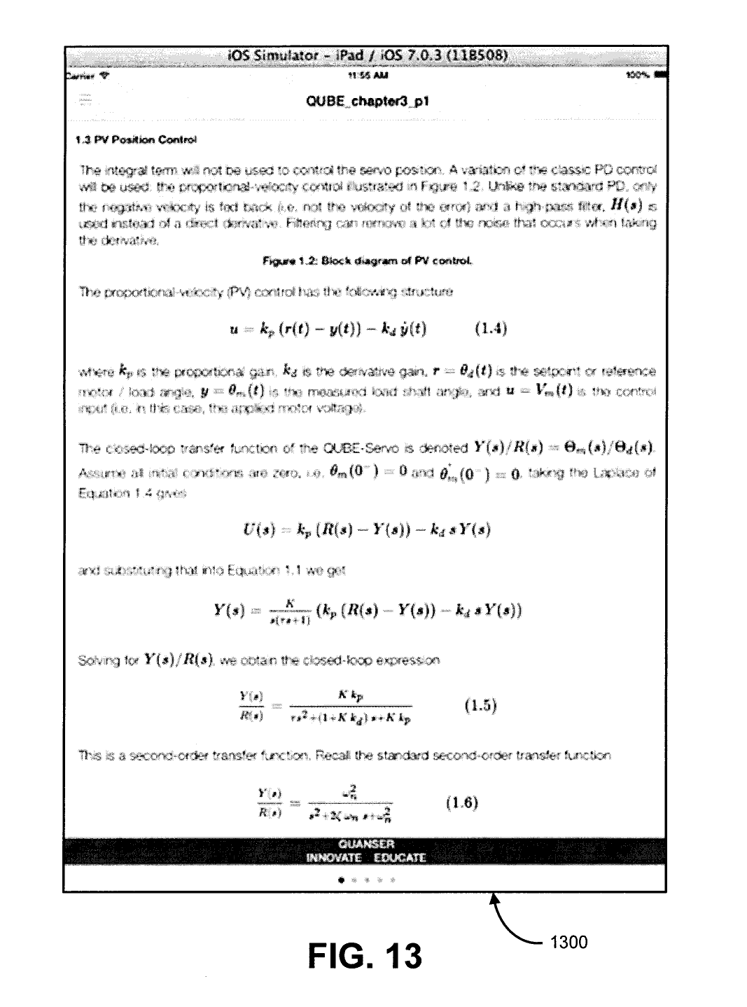

FIG. 13 illustrates a screen (1300) where mathematical equations are provided and rendered by the content player system, according to some embodiments. Mathematical equations can be written inline in text or as separate content elements laid out individually on the page.

Authors (104) may be able to write mathematic expressions in a platform independent text-based language such as LaTeX or MathML and the system parses the input text at runtime, extracting the mathematical expressions, rendering them using typesetting libraries built into the system, and inserting the resulting rendered math back into the text at the correct index and with scaling if necessary to ensure it fits within the text's line height. Alternatively, the math expressions can be preprocessed offline and included as vector images in the document's content bundle.

As an example of server-side math processing, where the system (10) may be adapted to conduct intelligent processing and caching of rendered math, the following example is provided.

When a document is published, the server may parse the entire document and locate any LaTeX math delimited by ‘$’ characters. To make the device-side application faster, these LaTeX expressions may be pre-parsed by the server and processed by LaTeX to generate images of the final typeset math. The images may be added to the document bundle and the source document XML may be altered to insert references to the generated images along with metadata extracted from LaTeX such as scaling factor and baseline depth. The framework may be configured to then display the images inline with text by applying the appropriate scaling and baseline offset to align the images of the typeset content with the surrounding text. To further improve server-side efficiency, each time the parser encounters a LaTeX expression, it is processed and the output is added to a database so that subsequent instances of the same expression can re-use the generated image and metadata immediately without needing to invoke the LaTeX compiler, which may be relatively slow.

There may be various advantages provided where an author (104) who will publish their document several times over the course of their work will not be regenerating the same math images each time, speeding up the time to author.

Other users (104, 105) using the same expressions may also benefit from precached LaTeX images.

The server also may also be configured to maintain information regarding the usage of each expression so that the system (10) can determine which expressions are most used and which are rarely used, allowing the system (10) to further optimize server-side processing and, if necessary reduce the memory and database size by pruning the least used expressions.

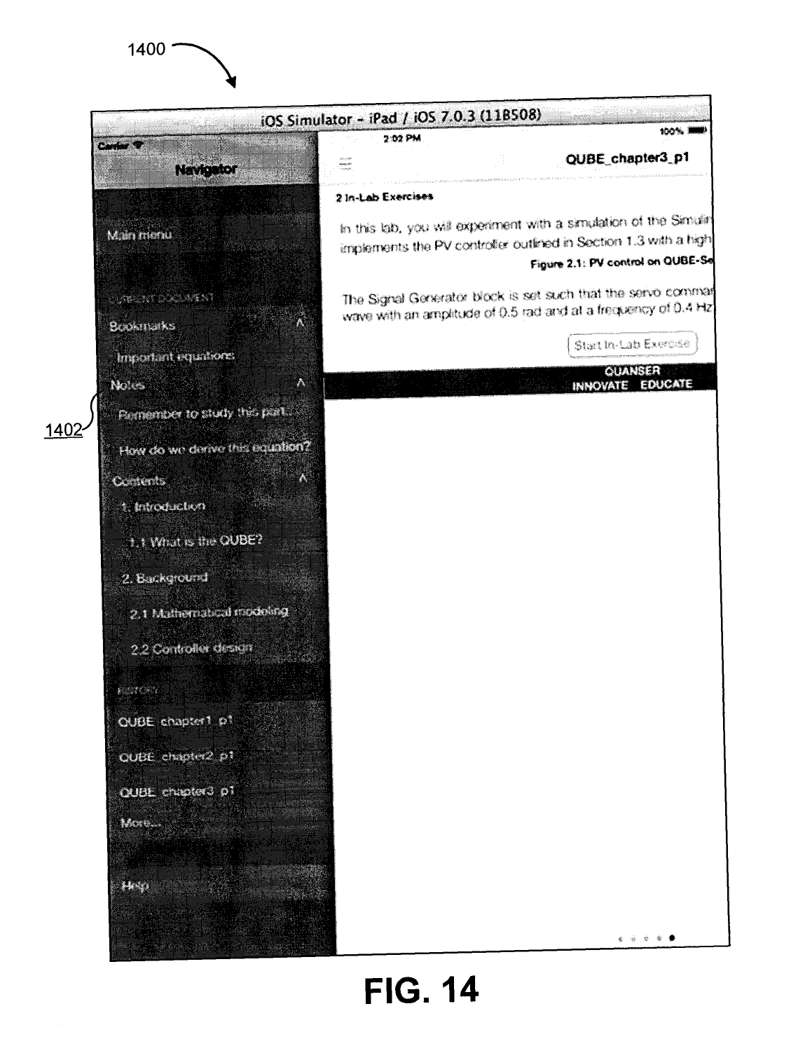

FIG. 14 illustrates a screen (1400) where a navigation menu (1402) is available on the left of the screen, according to some embodiments. When the user (104, 105) opens the navigation drawer, the drawer slides into view from the left side of the screen. The navigation drawer contains a list of links to aid in navigation including an expandable list of bookmarks for the current document, an expandable list of notes for the current document, an expandable tree view of the current document, a list of the most recently viewed sections and subsections, help, and a link to the main menu (library). The user (104, 105) can select any of these items to quickly navigate to that section.

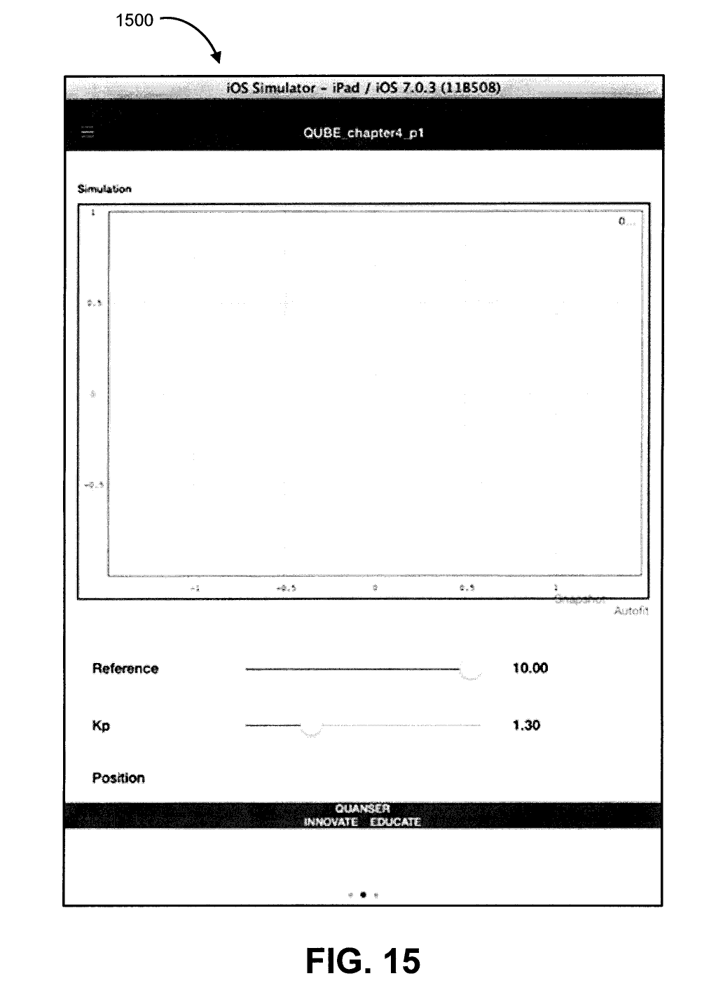

FIG. 15 illustrates a screen which contains an exercise where there is an activity for the user (104, 105) to perform, according to some embodiments. Typically, this may be used as an interactive portion of the exercise which may utilize controls (sliders, buttons, numeric inputs, selector inputs, etc.) as well as multimedia (audio, video, plots) and simulation systems or data streams connected to other remote systems (e.g., a running experiment connected via a wireless communication stream). The user (104, 105) interacts with the activity on this screen and gathers the information they need to answer the questions on the next page.

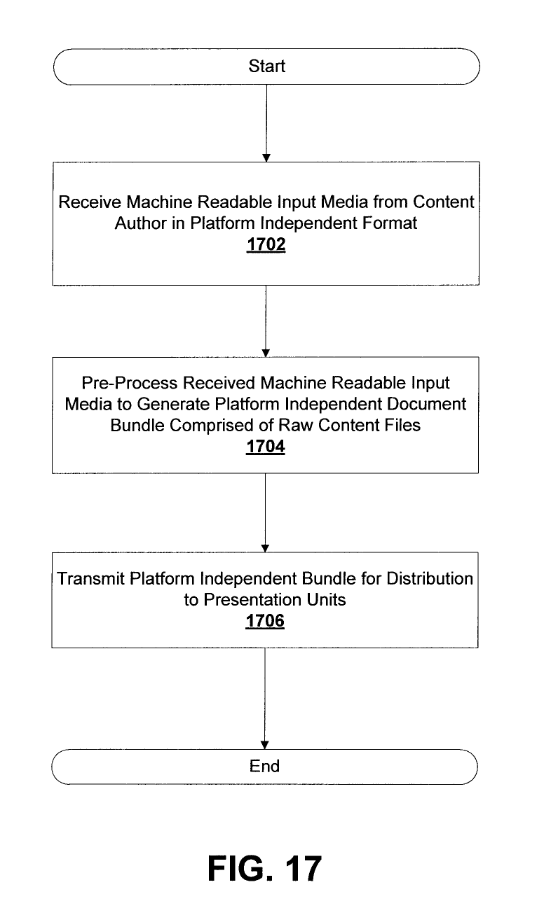

FIGS. 17-20 provides example workflows, according to some embodiments.

FIG. 17 is a workflow indicating steps of a computer implemented method (1700) for providing a digital content infrastructure, including the steps of: (1702) receiving machine-readable input media from a content author, the machine-readable input media being provided in a platform independent format, (1704) pre-processing the received machine-readable input media to generate a platform independent document bundle comprised of raw content files, and (1706) transmitting the platform independent bundle for distribution to one or more content presentation units.

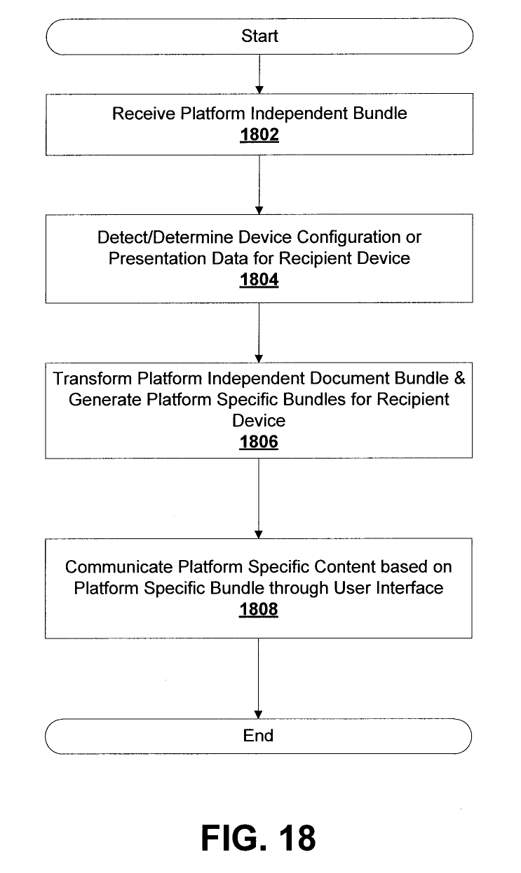

FIG. 18 is a workflow indicating steps of a computer implemented method (1800) for providing consuming digital content, including the steps of: (1802) receiving a platform independent bundle; (1804) detecting or determining device configuration or presentation data for the respective recipient computing device; (1806) transforming the platform independent document bundle using device configuration or presentation data to generate one or more platform specific bundles configured for use with the respective recipient computing device; and (1808) communicating, through a user interface having at least a display, platform specific content based at least on information provided in the platform specific bundle.

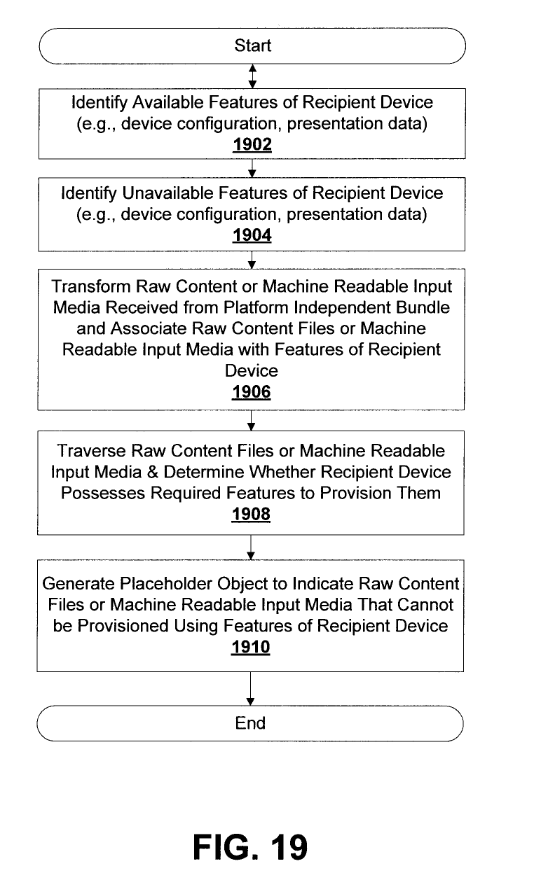

FIG. 19 is a workflow indicating steps of a computer implemented method (1900) for processing a platform independent bundle, including the steps of: (1902) identifying one or more available features of a recipient computing device, the one or more available features being at least a portion of a device configuration or presentation data; (1904) identifying one or more unavailable features of the recipient computing device, the one or more unavailable features being at least a portion of the device configuration or presentation data; (1906) transforming raw content files or machine readable input media included in the platform independent bundle to associate the raw content files or the machine readable input media with the one or more available features of the recipient computing device; (1908) traversing the raw content files or the machine readable input media to determine whether there are any raw content files or the machine readable input media that cannot be provisioned using only the one or more available features of the recipient device; and (1910) generating a placeholder object for incorporation the platform specific bundle associated with the raw content files or the machine readable input media to indicate which of the raw content files or the machine readable input media cannot be provisioned using only the one or more available features of the recipient device.

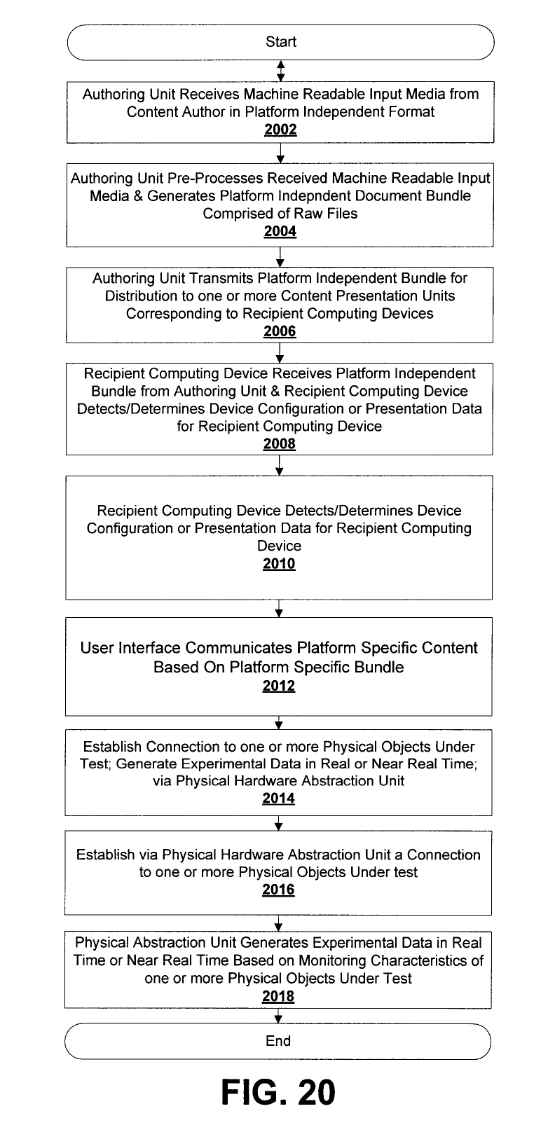

FIG. 20 is a workflow indicating steps of a computer implemented method (2000) for providing a digital content infrastructure, including the steps of: (2002) receiving, by an authoring unit, machine-readable input media from a content author, the machine-readable input media being provided in a platform independent format; (2004) pre-processing, by the authoring unit, the received machine-readable input media to generate a platform independent document bundle comprised of raw content files; (2006) transmitting, by the authoring unit, the platform independent bundle for distribution to one or more content presentation units each of the one or more content presentation unit corresponding to a recipient computing device of the one or more the recipient computing devices; (2008) receiving, by the one or more recipient computing devices, the platform independent bundle from the authoring unit; (2010) detecting or determining, by the one or more recipient computing devices, device configuration or presentation data for the respective recipient computing device; (2012) transforming, by the one or more recipient computing devices, the platform independent document bundle using device configuration or presentation data to generate one or more platform specific bundles configured for use with the respective recipient computing device; (2014) communicating, through a user interface having at least a display, platform specific content based at least on information provided in the platform specific bundle; (2016) establishing, by a physical hardware abstraction unit, a connection to one or more physical objects under test; (2018) generating, by the physical hardware abstraction unit, experimental data in real time or near real time based on monitoring of one or more characteristics of the one or more physical objects under test; and (2020) programmatically interfacing, by the physical hardware abstraction unit, with the one or more physical objects under test to manipulate one or more parameters associated with the operation of the one or more physical objects under test by causing the actuation of physical components of the one or more physical objects under test.

### 4.0 General

The present system and method may be practiced in various embodiments. A suitably configured computer device, and associated communications networks, devices, software and firmware may provide a platform for enabling one or more embodiments as described above.

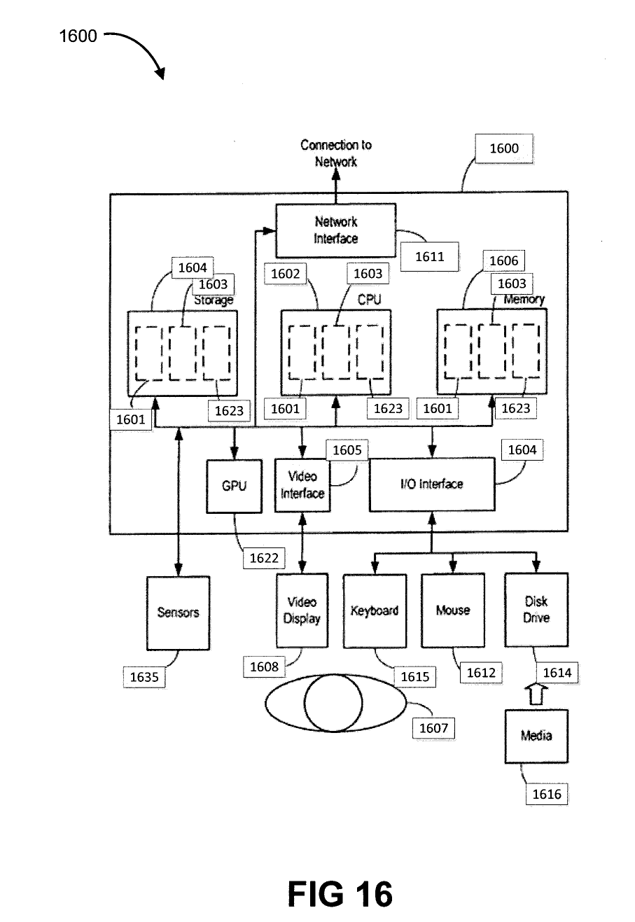

By way of example, FIG. 16 shows a computer device that may include a central processing unit (“CPU”) 1602 connected to a storage unit 1604 and to a random access memory 1606. The CPU 1602 may process an operating system 1601, application program 1603, and data 1623. The operating system 1601, application program 1603, and data 1623 may be stored in storage unit 1604 and loaded into memory 1606, as may be required. The computer device may further include a graphics processing unit (GPU) 1622 which is operatively connected to CPU 1602 and to memory 1606 to offload intensive image processing calculations from CPU 1602 and run these calculations in parallel with CPU 1602. An operator 1607 may interact with the computer device using a video display 1608 connected by a video interface 1605, and various input/output devices such as a keyboard 1615, mouse 1612, and disk drive or solid state drive 1614 connected by an I/O interface 1609. In known manner, the mouse 1612 may be configured to control movement of a cursor in the video display 1608, and to operate various graphical user interface (GUI) controls appearing in the video display 1608 with a mouse button. The disk drive or solid state drive 1614 may be configured to accept computer readable media 1616. The computer device may form part of a network via a network interface 1611, allowing the computer device to communicate with other suitably configured data processing systems (not shown). One or more different types of sensors 1635 may be used to receive input from various sources.

The present system and method may be practiced on computer devices including a desktop computer, laptop computer, tablet computer or wireless handheld.

The present system and method may also be implemented as a computer-readable/useable medium that includes computer program code to enable one or more computer devices to implement each of the various process steps in a method. In case of more than computer devices performing the entire operation, the computer devices are networked to distribute the various steps of the operation.

It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application may be implemented as a web service, where the mobile device includes a link for accessing the web service, rather than a native application.

The functionality described may be implemented to mobile platforms, including the iOS™ platform, ANDROID™, WINDOWS™ or BLACKBERRY™.

It will be appreciated by those skilled in the art that other variations of the embodiments described herein may also be practiced without departing from the scope. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made.

Except to the extent explicitly stated or inherent within the processes described, including any optional steps or components thereof, no required order, sequence, or combination is intended or implied. As will be understood by those skilled in the relevant arts, with respect to both processes and any systems, devices, etc., described herein, a wide range of variations is possible, and even advantageous.

1. A computer-implemented system for providing a digital content infrastructure on one or more computing devices having one or more processors and one or more non-transitory computer readable media, the digital content infrastructure adapted for automatically defining one or more control interfaces for communicating control signals to one or more physical objects under test to conduct one or more experiments based on underlying digital content of the digital content infrastructure; the system comprising:
an authoring unit configured to:
receive machine-readable input media from a content author, the machine-readable input media being provided in a platform independent format, pre-process the received machine-readable input media to generate a platform independent document bundle comprised of raw content files, and transmit the platform independent bundle for distribution to one or more content presentation units
the one or more content presentation units, each of the one or more content presentation unit corresponding to a recipient computing device of the one or more the recipient computing devices, the each of one or more content presentation units configured to:
receive the platform independent bundle from the authoring unit;
detect or determine device configuration or presentation data for the respective recipient computing device;
transform the platform independent document bundle using device configuration or presentation data to generate one or more platform specific bundles configured for use with the respective recipient computing device; and
communicate, through a user interface having at least a display, platform specific content based at least on information provided in the platform specific bundle; and
a physical hardware abstraction unit configured to:
responsive to a request to connect with a new physical object under test having an unknown configuration, determine a classification of the new physical obiect under test based on one or more other physical objects under test;
automatically define a new set of control interfaces for the new physical object under test by extending existing control interfaces based at least on the determined classification;
using the new set of control interfaces, generate experimental data in real time or near real time based on monitoring of one or more characteristics of the new physical object under test;
programmatically interface with the new physical object under test to manipulate one or more parameters associated with the operation of new physical object under test by causing the actuation of physical components of the new physical object under test; and
wherein the one or more content presentation units are operably connected to the physical hardware abstraction unit and configured to:
initiate a request for the experimental data by providing the request to the physical hardware abstraction unit;
transmit, through the physical hardware abstraction unit, instructions for manipulating the one or more parameters thereby causing the actuation of components of the new physical object under test;
receive the experimental data from the physical hardware abstraction unit; and
display the experimental data through the user interface of the content presentation unit.

2. (canceled)

3. (canceled)

4. (canceled)

5. The system of claim 1, wherein the content presentation unit is configured to process the platform independent bundle to generate the platform specific bundle by:
identifying one or more available features of the recipient computing device, the one or more available features being at least a portion of the device configuration or presentation data;
identifying one or more unavailable features of the recipient computing device, the one or more unavailable features being at least a portion of the device configuration or presentation data;
transforming the raw content files or the machine readable input media included in the platform independent bundle to associate the raw content files or the machine readable input media with the one or more available features of the recipient computing device;
traversing the raw content files or the machine readable input media to determine whether there are any raw content files or the machine readable input media that cannot be provisioned using only the one or more available features of the recipient device; and
generating a placeholder object for incorporation into the platform specific bundle associated with the raw content files or the machine readable input media to indicate which of the raw content files or the machine readable input media cannot be provisioned using only the one or more available features of the recipient device.

6. (canceled)

7. The system of claim 5, wherein the one or more available features of the recipient computing device include at least one of gesture recognition, a camera, a proximity sensor, a gyroscope, an accelerometer, a location sensor, touchscreen capabilities and a temperature sensor.

8. (canceled)

9. The system of claim 1, wherein the machine-readable input media includes machine-readable scripts adapted for utilizing computer-implemented features at the one or more content presentation units to facilitate the display or control of at least one of multi-rate simulations, interactions with a physical object under test, timers, algebraic loops, and plotted mathematical computations.

10. The system of claim 1, wherein the machine-readable input media includes machine-readable scripts adapted for simultaneously performing a simulation and performing experiments with a physical object under test.

11. The system of claim 1, wherein the device configuration or presentation data comprises an operating system, a form factor, a screen size, and a resolution of each of the one or more recipient devices, display type, display size, available memory or processing or communication resources, available display features, available output devices, available input devices, connection resources, communication protocol or a combination thereof.

12. (canceled)

13. The system of claim 1, wherein the display of the experimental data through the user interface of the content presentation unit includes displaying the experimental data in-line with the information provided in the platform specific bundle.

14. The system of claim 13, wherein each of the one or more content presentation units are configured to facilitate, through the user interface, interactions with the experimental data.

15. The system of claim 14, wherein interactions with the experimental data include at least one manipulations associated with the plotting of the experimental data.

16. The system of claim 1, wherein the physical hardware abstraction unit includes one or more predefined interfaces that is provided to the one or more content presentation units in the form of a computer-implemented library of possible manipulations for interaction with the physical object under test.

17. (canceled)

18. The system of claim 1, wherein the authoring unit is configured to provide a computer-implemented library of tools that are utilized by a user of the authoring unit to generate a plurality of logical rules defining the one or more parameters available for manipulation of the one or more physical objects under test; and defining the one or more characteristics of the one or more physical objects under test and how the one or more characteristics are affected by the one or more parameters.

19. (canceled)

20. (canceled)

21. (canceled)

22. (canceled)

23. (canceled)

24. (canceled)

25. (canceled)

26. (canceled)

27. (canceled)

28. (canceled)

29. The system of claim 1, wherein to pre-process the received machine-readable input media to generate a platform independent document bundle includes parsing the received machine-readable input media to determine which media includes mathematical equations;
and wherein the authoring unit is configured to validate the syntax of the mathematical equations; and pre-render validated mathematical equations as rendered images.

30. (canceled)

31. (canceled)

32. The system of claim 1, wherein the one or more content presentation units includes a simulation engine configured to:
generate simulations of mathematical relationships based at least on information provided in the platform specific bundle; and
display representations of the simulations through the user interfaces of the one or more content presentation units.

33. (canceled)

34. (canceled)

35. (canceled)

36. (canceled)

37. (canceled)

38. (canceled)

39. The system of claim 32, wherein the simulation engine is configured to generate the simulations alongside an experiment provisioned through the physical hardware abstraction unit.

40. (canceled)

41. (canceled)

42. (canceled)

43. (canceled)

44. (canceled)

45. (canceled)

46. (canceled)

47. (Cancelled)

48. (canceled)

49. A computer-implemented method for providing a digital content infrastructure on one or more computing devices having one or more processors and one or more non-transitory computer readable media, the digital content infrastructure adapted for automatically defining one or more control interfaces for communicating control signals to one or more physical objects under test to conduct one or more experiments based on underlying digital content of the digital content infrastructure; the method comprising:
receiving, by an authoring unit, machine-readable input media from a content author, the machine-readable input media being provided in a platform independent format;
pre-processing, by the authoring unit, the received machine-readable input media to generate a platform independent document bundle comprised of raw content files;
transmitting, by the authoring unit, the platform independent bundle for distribution to one or more content presentation units each of the one or more content presentation unit corresponding to a recipient computing device of the one or more the recipient computing devices;
receiving, by the one or more recipient computing devices, the platform independent bundle from the authoring unit;
detecting or determining, by the one or more recipient computing devices, device configuration or presentation data for the respective recipient computing device;
transforming, by the one or more recipient computing devices, the platform independent document bundle using device configuration or presentation data to generate one or more platform specific bundles configured for use with the respective recipient computing device;
responsive to a request to connect with a new physical object under test having an unknown configuration, determining a classification of the new physical object under test based on one or more other physical objects under test;
automatically defining a new set of control interfaces for the new physical object under test by extending existing control interfaces based at least on the determined classification;
communicating, through a user interface having at least a display, platform specific content based at least on information provided in the platform specific bundle;
establishing, by a physical hardware abstraction unit, a connection to one or more physical objects under test;
using the new set of control interfaces, generating, by the physical hardware abstraction unit, experimental data in real time or near real time based on monitoring of one or more characteristics of the one or more physical objects under test; and
programmatically interfacing, by the physical hardware abstraction unit, with the one or more physical objects under test to manipulate one or more parameters associated with the operation of the one or more physical objects under test by causing the actuation of physical components of the one or more physical objects under test.

50. A non-transitory computer-readable medium, storing machine readable instructions, which when executed by a processor, cause the processor to perform steps of a method for providing a digital content infrastructure on one or more computing devices, the method comprising:
receiving, by an authoring unit, machine-readable input media from a content author, the machine-readable input media being provided in a platform independent format;
pre-processing, by the authoring unit, the received machine-readable input media to generate a platform independent document bundle comprised of raw content files;
transmitting, by the authoring unit, the platform independent bundle for distribution to one or more content presentation units each of the one or more content presentation unit corresponding to a recipient computing device of the one or more the recipient computing devices;
receiving, by the one or more recipient computing devices, the platform independent bundle from the authoring unit;
detecting or determining, by the one or more recipient computing devices, device configuration or presentation data for the respective recipient computing device;
transforming, by the one or more recipient computing devices, the platform independent document bundle using device configuration or presentation data to generate one or more platform specific bundles configured for use with the respective recipient computing device;
responsive to a request to connect with a new physical object under test having an unknown configuration, determining a classification of the new physical object under test based on one or more other physical objects under test;
automatically defining a new set of control interfaces for the new physical object under test by extending existing control interfaces based at least on the determined classification;
communicating, through a user interface having at least a display, platform specific content based at least on information provided in the platform specific bundle;
establishing, by a physical hardware abstraction unit, a connection to one or more physical objects under test;
using the new set of control interfaces, generating, by the physical hardware abstraction unit, experimental data in real time or near real time based on monitoring of one or more characteristics of the one or more physical objects under test; and
programmatically interfacing, by the physical hardware abstraction unit, with the one or more physical objects under test to manipulate one or more parameters associated with the operation of the one or more physical objects under test by causing the actuation of physical components of the one or more physical objects under test.
